(19) United States
(12) Patent Application Publication
(10) Pub. No.: US 2010/0225239 A1
(43) Pub. Date: Sep. 9, 2010

(54) METHODS AND APPARATUS FOR A HIGH POWER FACTOR, HIGH EFFICIENCY, DIMMABLE, RAPID STARTING COLD CATHODE LIGHTING BALLAST

(75) Inventor: Ray James King, Carolina Beach, NC (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: PureSpectrum, Inc.

(21) Appl. No.: 12/397,921

(22) Filed: Mar. 4, 2009

(51) Int. Cl. H05B 41/36

(52) U.S. Cl. 315/224; 315/284

(57) ABSTRACT

Methods and apparatus for powering a dimmable ballast operating a gas-discharge bulb in a cold cathode mode of operation, that is, without requiring heating of filaments. The ballast circuit includes a rectifier, bypass capacitor, driver circuit, and a tank circuit that includes a resonant circuit that are configured to ionize a light source, such as a fluorescent lamp, every half cycle of the input voltage. The bypass capacitor supplies energy to produce a high frequency current introduced into the resonant circuit to continually recycle energy in the resonant circuit, resulting in a ballast with a high power factor. A tank circuit comprising a tapped inductor operating in a non-saturated or limited saturated mode provides additional voltage to the bulb to ionize the bulb. The ballast may be dimmed and combined with other energy savings circuitry.

### FIELD OF THE DISCLOSURE

The present disclosure relates generally to electronic lighting ballasts and, more particularly, to methods and apparatus for high efficiency ballasts operating in a cold cathode mode of operation, wherein the ballast has a with a high power factor that can also be effectively dimmed.

### SUMMARY

Methods and apparatus for powering dimmable ballast circuits having a high power factor are disclosed, and which operate with various bulbs in a cold cathode mode. Specifically, gas discharge lamps, such as fluorescent lamps, without heating filaments are used with a ballast. The ballast can be operated with a dimmer and various energy savings circuits for added flexibility and efficiency.

A described dimmable ballast circuit includes a power source connected to a first node and a second node, the power source having a current that alternates at a line frequency. The first node and the second node are connected to each other via an energy storage device in the form of a capacitor that stores energy and provides current at a first (high) frequency, which exceeds the line frequency of the power source and presents a high impedance to the line frequency. This capacitor is small enough in capacitance value relative to the load that it does not distort the rectified AC input from the power source. A first switch is operable to selectively couple the energy storage device to a resonant circuit via the first node. The resonant circuit has a resonant frequency and stores energy during a first portion of a cycle of the first frequency thereby causing light to be emitted. A second switch is operable to selectively couple the resonant circuit via the second node to cause energy stored in the resonant circuit to be substantially recycled via the capacitor. When the second switch closes, this reverses the voltage across the lamp during a second portion of the cycle at the first frequency, also causing light to be emitted.

The above ballast can be adapted to provide energy to a resonant circuit, also known as a “tank circuit” that operates cold cathode fluorescent lights (“CCFL”) in a highly efficient manner. Further, this ballast can be used with bulbs without requiring heating of the filaments to facilitate ignition of the bulb.

### BACKGROUND

In the field of light sources (e.g., gas discharge lamps, fluorescent lamps, light emitting diodes, etc.), many light sources can present a negative resistance that causes the power source to increase the amount of current provided. If the current were not limited in some manner during operation, the current would rapidly increase until there was a catastrophic failure of the light source. To limit the current, a ballast circuit is typically provided that controls the amount of current provided to the light source to maintain a steady state, flicker-free generation of light. Initial ballasts were of the magnetic type, which presented a large inductance to the power source with poor secondary coupling. Such ballasts resulted in the current being largely in phase at the load with respect to the voltage provided by the power source, which resulted in a high power factor. However, magnetic ballasts have very poor efficiencies. Magnetic ballasts have other disadvantages including being relatively large and heavy, and are prone to producing an audible humming sound. Further, they are temperature dependent and when cold they may present difficulties in causing ionization in the lamp and therefore generating light. Magnetic ballasts have largely been replaced by quieter, smaller electronic ballasts to provide the proper starting and operating power to fluorescent lamps. Further, electronic ballasts are generally smaller and more compact and can be integrated with a fluorescent bulb (tube) to produce compact fluorescent lamps (“CFLs”). Electronic ballasts rely on electronic switching circuitry to switch the input voltage to produce a high frequency (typically 20 kHz or higher) voltage to the nodes of the fluorescent lamp. Typically, the ballast includes a “tank circuit” (a.k.a resonant circuit) which increases the line voltage to a higher voltage, typically anywhere from 200 to 600 volts, so as to initiate ionization and maintain the light output of the fluorescent lamp during operation.

The power factor is generally defined as the relationship of the real power to the apparent power. However, electronic ballasts often exhibit a lower power factor, which means the current is not in phase with the voltage. A lower power factor means the power company has less efficiency in energy transmission. Further, as the use of fluorescent lighting becomes widespread, a lower power factor in residential applications becomes more of a concern to the power company. Some ballasts have incorporated a power factor correction circuit, which may include an integrated circuit, capacitor, and other components, which monitor and adjust the current flow so as to be in phase with respect to the line voltage, however, such power factor correction circuits generally have poor efficiency caused by losses due to these components and increase the cost of the ballast. Further, such ballast circuits generally include a low temperature rated, high voltage electrolytic capacitor that substantially limits the life of the ballast.

Electronic ballasts are generally relied upon exclusively for compact fluorescent light (“CFL”) because of their smaller size and weight, relative to magnetic ballasts, which allows a CFL to incorporate both a lamp (light source) and a ballast. Hence, a CFL has an integrated ballast with the lamp. In other applications, such as when using “linear” or “tubular” fluorescent bulbs, the ballast is separate from the lamps, allowing the lamp to be replaced separately from the ballast. Many fluorescent lamps have filaments, which are heated to facilitate ionization. Other fluorescent lamps do not, and these are referred to as cold cathode lamps or bulbs. Bulbs without filaments have fewer components and are easier to manufacturer, but the absence of a heating filament requires a higher voltage to obtain ignition or ionization. Further, the heating of the filaments results in lower energy efficiency. Thus, there is a need for a highly efficient ballast capable of operating a bulb in a cold cathode mode of operation.

In the past, using ballasts precluded the ability to dim the light source. It becomes difficult to sustain ionization in the fluorescent tube at low dimming levels with conventional ballasts, causing the lamp to flicker. Newer ballasts now allow the light source to be dimmed to a degree, but still present problems in that the dimming is over a narrow range of light output. Specifically, many ballasts may effectively limit dimming to a narrow range of the light output before the light source is extinguished, or the lamp begins to flicker in an annoying manner. Further, the energy savings is not commensurate with the amount of light that is dimmed. Thus, if the light is dimmed a certain level (e.g., 25% of its output), one would expect the energy savings to be the commensurate (e.g., only 25% energy is used). However, in many cases, only a small fraction of energy is saved given the reduction in light output. Thus, the benefit of saving energy is not fully realized. Consequently, there is a need for a highly efficient and dimmable ballast for lighting applications operation in a cold cathode mode.

### BRIEF DESCRIPTION OF THE DRAWINGS

FIGS. 1a-g illustrate a conventional prior art ballast circuit having a power factor correction circuit and various voltage waveforms produced therein.

FIGS. 2a-c illustrate a block diagram of one embodiment of ballast circuit according to the principles of the present invention having a high power factor in accordance with the present invention, along with voltage waveforms produced therein.

FIG. 3 is a flow diagram of a process that the example ballast circuit of FIG. 2a may implement.

FIGS. 4a and 4b are schematic diagrams of example circuits that may implement the example process of FIG. 3.

FIG. 4c illustrates waveforms of the voltage in conjunction with use of a dimmer.

FIG. 4d illustrates a schematic diagram of another embodiment of the present invention.

FIG. 5 illustrates a voltage waveform diagram associated with the operation of an exemplary rectifier of the circuit of FIG. 4a.

FIG. 6 is a voltage waveform diagram that illustrates the operation of an exemplary regulator of the circuit of FIG. 4a.

FIGS. 7 and 8 are circuits that illustrate the operation of the example circuit of FIG. 4a.

FIG. 9 is a voltage waveform diagram that illustrates the voltage at the light source in the resonant circuit of FIG. 4a.

FIGS. 10a-c illustrates one embodiment of an inductor core used in the tank circuit of the ballast.

FIG. 11 illustrates another embodiment of the ballast configured to operate in a cold cathode fluorescent bulb configuration.

FIG. 12 illustrates voltage waveforms associated with the cold cathode ballast during operation.

FIG. 13 illustrates the cold cathode ballast circuit with a dimmer circuit.

FIGS. 14a-b illustrate voltage waveforms associated with the cold cathode ballast with a dimmer.

FIG. 15 illustrates a cold cathode tank circuit connected to an energy savings circuit.

FIG. 16 illustrates one embodiment of the tank circuit of the cold cathode ballast configured to generate a signal voltage.

### DETAILED DESCRIPTION

Methods and apparatus for dimmable ballasts with a high power factor are described herein, including operating in a cold cathode configuration. In the described examples, a dimmable ballast circuit having a high power factor is described that directly interfaces a power source with a light source via a single resonant circuit. In addition, the described dimmable ballast includes a high frequency filter capacitor to reduce high frequency energy from entering the power supply during its operation to increase efficiency.

When an element is said to be “coupled” to another element, the elements can be connected or coupled to one another either directly (without intervening elements) or indirectly (with intervening elements). However, if an element is said to be “directly coupled” to another element, no intervening elements are present. If “connected,” then it generally means that no intervening elements are present.

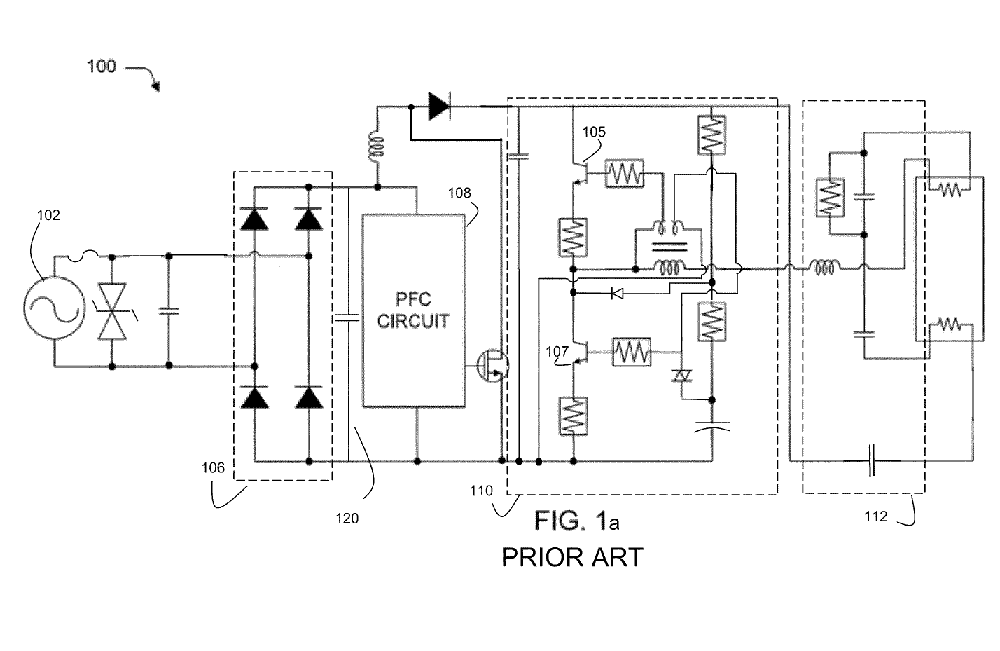

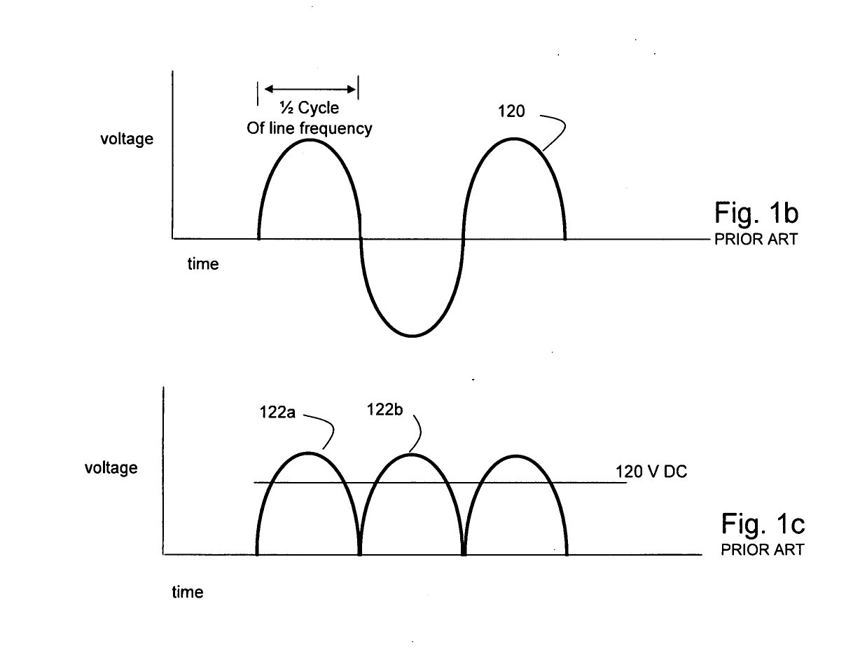

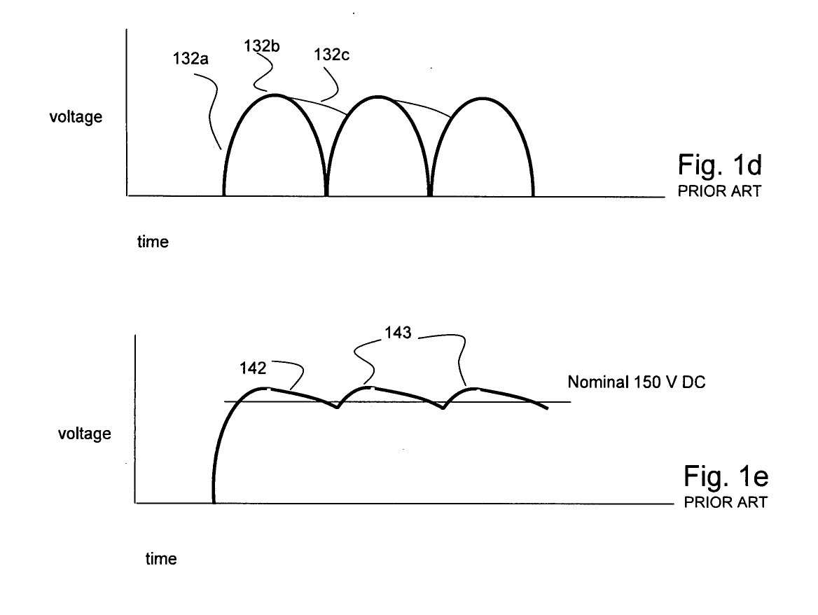

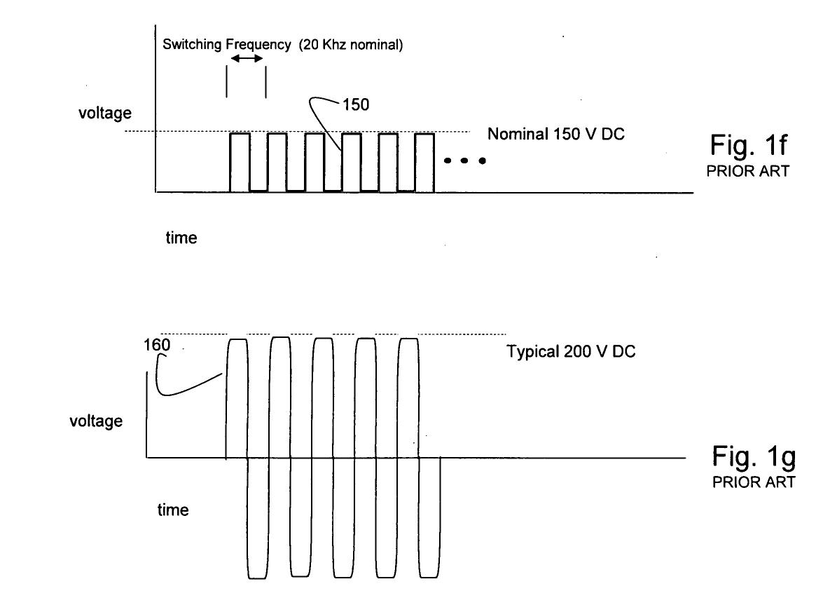

FIG. 1 illustrates one embodiment of a prior art electrical circuit ballast, comprising a power source 102, which provides household power, which typically is in the form of 120VAC/60 Hz in the U.S., or 240 VAC/50Hz in other countries. Although various embodiments herein may be disclosed in terms of “household voltage,” this means any readily available voltage, and does not preclude application to other commercial or industrial voltages. Thus, for example, the principles of the present invention could be adapted to other voltages and frequencies, such as the 400 Hz AC systems used in commercial aircraft. Hence, other variations are possible regarding the power source characteristics, which may impact the precise values of various components.

A rectifier 106 comprising a full wave bridge diode assembly rectifies the AC voltage to produce unfiltered, rectified DC voltage. The aforementioned power factor correction circuit 108 may be present, and typically may incorporate a high voltage electrolytic capacitor or other capacitor, integrated circuit, and other components. The switching circuit 110 typically comprises two transistors for switching at a high frequency, and incorporates a self resonant circuit for driving the transistors to switch at a high frequency, typically 20 kHz or higher. A so-called “tank” circuit 112 includes a combination of induction and capacitance values that has a resonant frequency, and which increases the DC line voltage to a higher value and frequency, typically around 200 volts or more. In some contexts, the bulbs can be considered as part of the tank circuit, since the removal of the bulb may disconnect a capacitor impacting the resonant frequency of the tank circuit. However, unless noted otherwise, the tank circuit as referenced herein generally does not include the bulb. However, in the context of a CLF having an integrated lamp, a bulb is presumed to be connected with the tank circuit. In various countries, such as in the U.S., Europe, or Asia, the resistance value of the filaments in the bulbs is respectively standardized to different values.

The voltage waveform produced by the power source 102 is shown in FIG. 1b. Typically, the voltage waveform 120 is a sine shaped waveform at a frequency of 60 Hz or 60 cycles per second, and thus a half cycle is 1/120 second. The voltage typically is rated at 120 volts (RMS) or about 160 volts peak in the U.S., although some minor variations may exist (e.g., some power companies may operate at 115 or 110 volts AC).

The voltage waveform 120 is provided to the input into the rectifier circuit of FIG. 1a, and the voltage waveform 122 in FIG. 1c is the output of the rectifier. In this instance, the negative portion of the waveform in FIG. 1b is inverted to form a positive portion 122b, thereby producing a rectified (AC) sine wave shape. Thus, each half cycle has the shape of a portion of a sine wave. The frequency of each waveform 122a, 122b is 120 Hz, or ½ the cycle time of the line frequency of 60 Hz (twice the rate). Consequently, the waveform shown is an unfiltered rectified sine wave.

In prior art ballasts, a large electrolytic capacitor is often incorporated either by itself, or as part of the power factor correction circuitry 108, to filter the 120 Hz ripple. The presence of this type of filter capacitor, which is designed to filter out the 120 Hz ripple in the rectified power wave, produces a waveform 132 shown in FIG. 1d. In FIG. 1d, the rise of the voltage 132a charges the electrolytic capacitor until a peak point of the waveform at 132b. At this point, the output voltage would normally be declining, but the capacitor discharges at 132c over time, preventing the rapid decrease in voltage of the rectified output. The result is the voltage waveform 142 shown in FIG. 1e, which after initial startup has a series of crests 143, which are followed by a slight decreasing voltage in between. The average voltage is typically slightly higher than the nominal AC line voltage rating, typically around 150 V, but in DC, but other embodiments with dedicated power factor correction circuits could be as high as 350v.

The switching circuit 110 of FIG. 1a alternatively switches transistor T1 105 and T2 107 on and off in a rapid sequence. Typically, while T1 is closed, T2 is open, and vice versa. However, there is typically some “dead time” between these events when both switches are open. The switching on and off typically occurs anywhere from 20 kHz to 100 kHz, but can occur higher. Certain energy saving standards require a switching frequency of at least 40 kHz frequency. For illustrative purposes, the frequency can be assumed to be around 20 kHz. Generally, 18 kHz is a lower limit, and 80 kHz may be an upper limit.

In FIG. 1f, the switching voltage present across the transistor is shown as a square wave 150. Typically, the switching frequency is very high (e.g., 20 kHz) compared to the line frequency of 60 Hz (or 50 Hz), so that the time scale in FIG. 1f is different (i.e., expanded) relative to the time scale of the prior diagrams. The output of the transistors is essentially a square wave input to the tank circuit 112 of FIG. 1a.

The function of the tank circuit, which has a resonant frequency and which is tuned to be a slightly lower frequency than the switching frequency, is to re-circulate the energy introduced and “step up” the voltage introduced to around 200-600 volts that is provided to the bulb. This voltage is high enough to initiate ionization on the fluorescent light bulb. The bulb itself, once ionized, serves to limit the voltage across its terminals. Thus, FIG. 1g illustrates a generally shaped sine wave 160 having a flattened top due to clamping caused by the ionization of the bulb, which for practical purposes can be considered a square wave. The wave of FIG. 1b has the same high switching frequency as FIG. 1a, but at a higher voltage, which would typically be present at the terminals of the lamp. A DC coupling capacitor filters out the DC component of the input into the tank circuit and causes the current flowing into the tube to be balanced, thus creating the negative portion of the sine wave in FIG. 1g (e.g., the symmetrical portion of the wave below zero volts). In the prior art, the bulb, once ionized is continuously ionized during normal operation.

While this type of prior art circuit does provide suitable light generation in a lamp, it has difficulty in allowing dimming of the light source over a wide range of light output. Further, this type of prior art circuit is not energy efficient when dimmed. If it does not have the power factor correction circuit, then its power factor is low. If the power factor correction circuit is present, then the circuit contains additional components, increasing its cost.

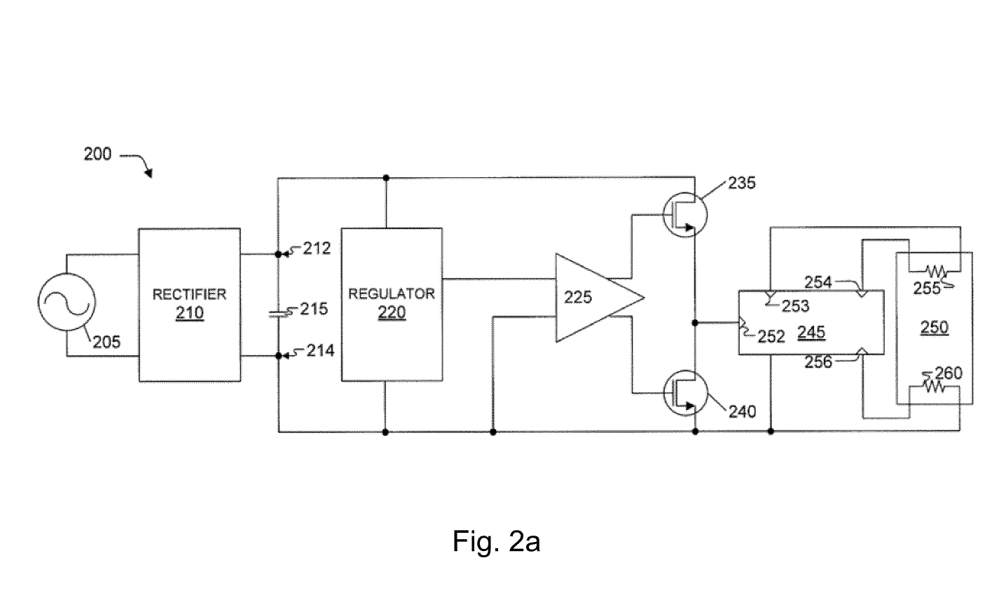

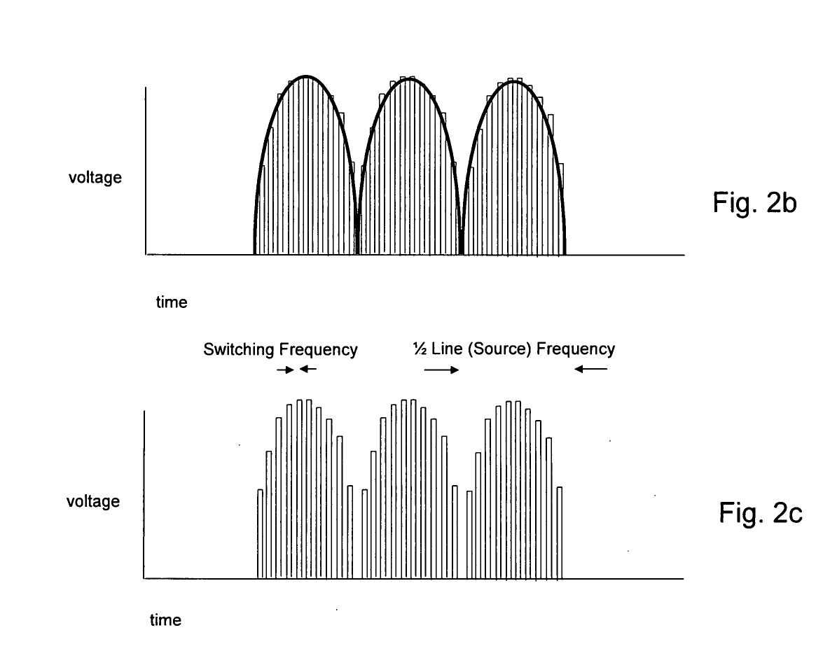

FIG. 2 illustrates a block diagram of one embodiment of the present invention wherein ballast circuit 200 is configured to have a high power factor, generally approaching a power factor of unity (e.g., 0.90-0.99, etc.). In particular, the example ballast circuit 200 includes a power factor correction capability that is performed in a single stage of impedance transformation, thereby eliminating the need for a separate high power factor correction circuit while retaining substantially the same functionality. Thus, fewer components are required relative to the prior art. However, the presence of a power factor correction circuit in a ballast may adversely interact when used with a dimmer.

In the example of FIG. 2, the ballast 200 includes a power source 205 that is connected to a rectifier 210. The power source 205 is typically an alternating voltage source that provides commercially available voltage (e.g., 120 or 240 VAC) having a magnitude alternating at a line frequency (e.g., 60 Hertz (Hz)). A line filter (not shown) is also typically incorporated to prevent noise from being introduced back into the power network. Rectifier 210 is typically a full wave rectifier that inverts the negative magnitude of the voltage provided via the power source, thereby doubling the frequency of the line voltage (e.g., to 120 Hz). Rectifier 210 conveys the rectified voltage onto a first node 212 and a second node 214. The output of the rectifier 210 provided to nodes 212 and 214, is similar in waveform to that shown in FIG. 1c. The rectifier provides an unfiltered, rectified voltage. This voltage is DC, and has the shape of a rectified AC voltage waveform.

The first node 212 and the second node 214 are connected via a high frequency energy storage device, such as a polypropylene capacitor 215, also referred to as a bypass capacitor herein. In the example of FIG. 2, the capacitance value of the capacitor 215 is selected to have a value such that it presents a large impedance to the rectified voltage (i.e., at the line frequency), thereby not substantially affecting the rectified voltage provided via rectifier 210 during operation of the ballast. Typically, this would present an impedance of several thousand ohms at the line frequency. This would provide a low impedance at the switching frequency, typically in the range of less than 30 ohms. This is in distinction to the prior art that uses a high voltage, low frequency capacitor across the output of the rectifier, such as a large value electrolytic capacitor, to filter out the 120 Hz ripple due to the line frequency, which removes the “valleys” in the rectifier output. The capacitance value of capacitor 215 in the example of FIG. 2 is selected to store energy which is released at a high frequency, generally in the kilohertz (20-80 kHz) range. As such, capacitor 215 in the example of FIG. 2 has value of approximately 0.1 to 3 microfarads (μF) and is made of any suitable material (e.g., polypropylene, etc.) for a ballast having a power output as required, which in this embodiment is approximately 25 watts. In other embodiments, capacitor 215 may have a value of approximately 1 to 30 μF for a ballast having a power output of approximately 120 to 250 watts. Stated in more general terms, capacitor 215 generally has a capacitance value in the range of 4 to 120 nanofarads (nF) per watt of power of the output lamp, and typically around 50 nF/watt when 120VAC is used. If 240VAC is used, then capacitance value is half the above. The capacitor 215 is typically a polypropylene capacitor that has a lifespan much greater than larger electrolytic capacitors that typically are used in conventional ballasts.

Ballast circuit 200 also includes a regulator 220, (generically referred in the industry as a housekeeping supply circuit) connected to nodes 212 and 214. Regulator 220 generates a substantially constant voltage that exceeds a first threshold (e.g., 10 volts, etc.) to provide power to a driver 225. Because the voltage at nodes 212 and 214 is not filtered, a regulator is required to provide a steady input voltage to the driver 225. The voltage waveform from the rectifier has at each half cycle a “valley” wherein the voltage drops to zero or near-zero, albeit for a short time. In the illustrated example, the driver 225 is configured to alternately actuate one of a first transistor 235 and a second transistor 240 at a high frequency, referred to herein as the switching frequency, typically at a frequency of 20 kHz or more. The example transistors 235 and 240 are both implemented using vertical N-Channel metal oxide semiconductor (NMOS) field effect transistors, although one of ordinary skill in the art would know that the transistors 235 and 240 can be implemented by any other suitable solid state switching device (e.g., a P-channel metal oxide field effect transistor, an insulated gate bipolar transistor (IGBT), a lateral N-channel mode MOS transistor, a bipolar transistors, a thyristor, gate turn off (GTO) device, etc.).

Driver 225 and transistors 235 and 240 form a half-bridge topology that is implemented to cause a resonant circuit or “tank circuit” 245 to power a light source 250 in the illustrated example. To form the half-bridge topology, the drain of the first transistor 235 is connected to the first node 212 and the source of the second transistor 240 is connected to the second node 214. Thus, the voltage present on the node 212 and the drain of the first transistor 235 is the rectified voltage waveform 260 shown in FIG. 2b. The gates of the transistors 235 and 240 are both connected to first and second outputs of the driver 225, respectively, and the source of the transistor 235 is connected to the drain of the transistor 240, both of which are also connected to the resonant circuit 245. Because the transistor 235 switches the voltage from node 212 at a high frequency square wave 265 in FIG. 2b, the resulting voltage at input 252 is the high frequency square wave modulated by the line frequency as shown in FIG. 2c. Both FIG. 2b and 2c illustrate the aforementioned “valleys” 260 having a period of twice the line frequency.

The resonant circuit 245 has a high resonant frequency that is slightly lower than the switching frequency of the transistors. Typically, the lowest frequency operable for practical purposes is 18 kHz, and the upper limit is limited by other practical considerations, but maybe as high as 80 kHz. The resonant circuit is also connected to the second node 214 and a light source 250 (e.g., a gas discharge lamp, a fluorescent lamp, a light emitting diode (LED), etc.).

In particular, a first input 252 is connected to the source and drain of NMOS transistors 235 and 240. A first output 253 of the resonant circuit 245 is connected to a second input 254 of the resonant circuit 245 via a first filament 255 of the light source 250. Further, in the example of FIG. 2, a second output 256 of the resonant circuit 245 is connected to the second node 214 via a second filament 260 of the light source (e.g., lamp or tube) 250. As will be described in detail below, the resonant circuit 245 can be viewed as a coupling device matching impedance of the tube with the power source. The resonant circuit functions to store energy and selectively charges and discharges energy into the light source 250 at the switching frequency, which greatly exceeds the line frequency of the rectified current which is at the line frequency, thereby exciting the light source 250 to visually emit light. Further, the resonant circuit 245 presents an impedance to the power source 205 to thereby limit the current flowing into the light source 250. The tank circuit increases the input line voltage by circulating energy in the tank circuit, and presents an alternating voltage across the ends of the bulb 250. In the present invention, the bulb is ionized or said to be ignited at the beginning of each half cycle (120 Hz) of the input power voltage.

The tank circuit presents a variable input impedance. When the input voltage at node 252 is just rising, such as shown with square wave 270 of FIG. 2c, the impedance is higher because of a high Q factor (which represents an unloaded circuit) of the tank circuit. When the input voltage is low, the bulb has not been ionized and the tank circuit has a high Q factor. As the input voltage increases, the bulb ionizes resulting in a lower Q factor of the tank circuit, allowing more current to flow. This means the current on the load is largely in phase with the voltage from the source, which results in a high power factor for the ballast.

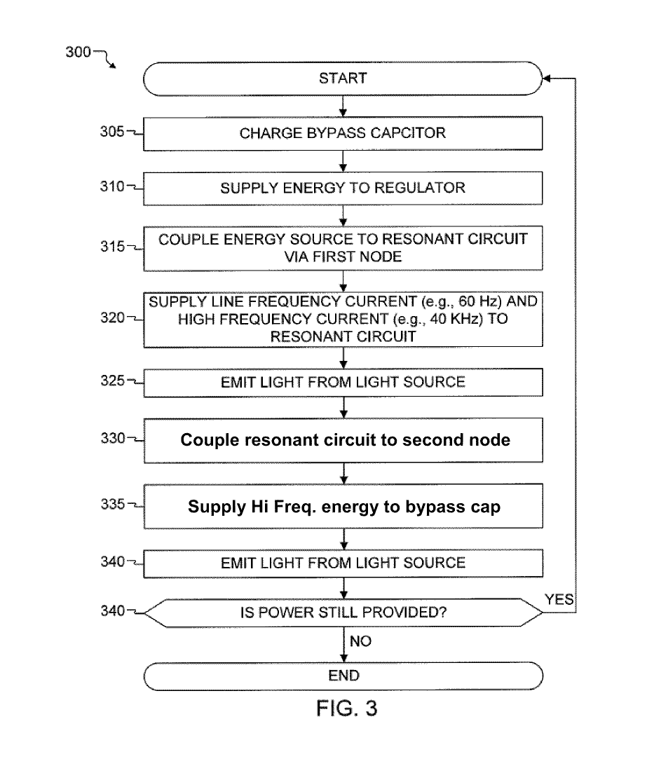

FIG. 3 illustrates an exemplary process 300 that ballast circuit 200 may implement when connected to a power source (e.g., an alternating current source, etc.). If power is provided to the ballast, exemplary process 300 begins by charging a high frequency bypass capacitor (corresponding to capacitor 215 of FIG. 2a). Specifically, the bypass capacitor presents a large impedance to a line frequency current of the power source (e.g., 60 Hz, 120 Hz, etc.) (block 310). In addition, exemplary process 300 supplies energy to power a regulator that provides power to actuate a driver circuit, for example (block 310). In the example of FIG. 3, exemplary process 300 couples the energy source (e.g., a power supply, etc.) to a resonant circuit via a first node (block 315). In response, the energy source supplies energy at the line frequency (60 Hz) which is combined with the energy from the bypass capacitor at a high frequency (e.g., about 40 KHz, or whatever is the switching frequency) to the resonant circuit (block 320). In particular, the bypass capacitor provides the high frequency energy in the form of a current via the first node when the first transistor is closed. When the resonant circuit receives the line frequency energy and the high frequency energy (in the form of current), the resonant circuit has a voltage with a positive magnitude, thereby causing a light source connected to the resonant circuit to ionize the gas and emit light there from for the first half cycle (block 325). Because the value of the bypass capacitor is of a relatively small value, it only contributes a high frequency charge to the resonant circuit. The energy at the line frequency (e.g., 60 Hz) is also applied to the resonant circuit, but is limited by the reactance of capacitor 442. This capacitor functions to largely limit the energy from the 60 Hz input. The inductor 444 is also in the current path, but is designed so as to not be saturated by the current from the 60 Hz source.

After emitting light from the light source, exemplary process 300 then couples the resonant circuit to the second node (block 330). As a result, the resonant circuit has a voltage with a negative magnitude, and the energy is circulated within the tank circuit, thereby causing the light source connected to ionize the gas and emit light during the second half cycle (block 340). During this time, the bypass capacitor is also charged from the power source. Exemplary process 300 determines if power is still provided by the energy source (block 345). If power is provided, the exemplary process returns to block 305. On the other hand, if power is not provided to the ballast, the exemplary process ends. In the present invention, there is no ionization during a brief time period while the rectified unfiltered DC input voltage is in a “valley.” This point corresponds to the zero crossing point of the AC input line voltage. The time period during which the bulb is not ionized is typically at least 200 microseconds. However, this short time period is not perceivable to the human eye and the bulb may be generating light due to persistence of the phosphor in the bulb.

In the example of FIG. 3, the high frequency energy in exemplary process 300 is stored in the bypass capacitor, which continually recycles the high frequency energy during its operation. The high frequency current has a frequency generally in the range of approximately 20 to 80 KHz. Thus, according to exemplary process 300, the high frequency energy continually recycles via the bypass capacitor at the switching frequency, thereby preventing substantial energy loss. Further, the energy source is directly connected to the resonant circuit via a low impedance path to prevent substantial loss of energy. Accordingly, the resulting circuit implements a process generally having a high power factor, high efficiency, and a near ideal crest factor.

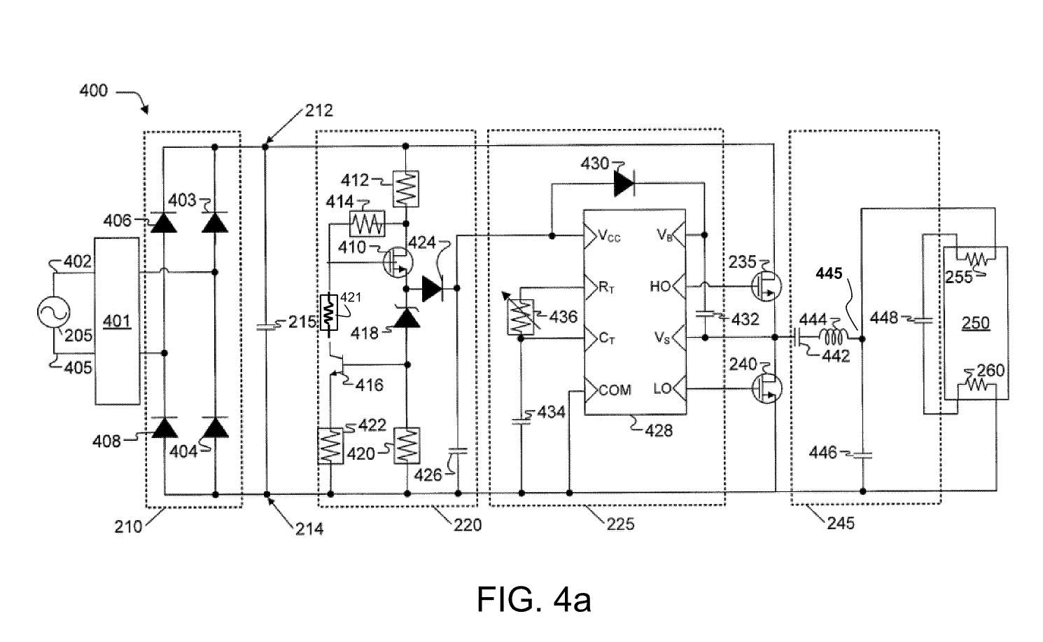

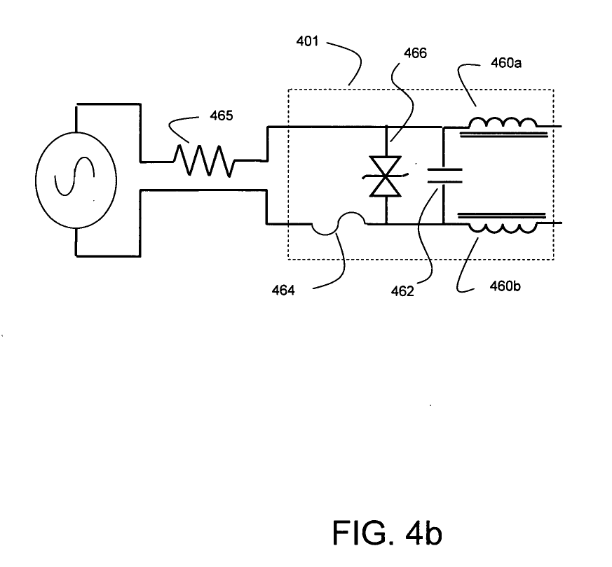

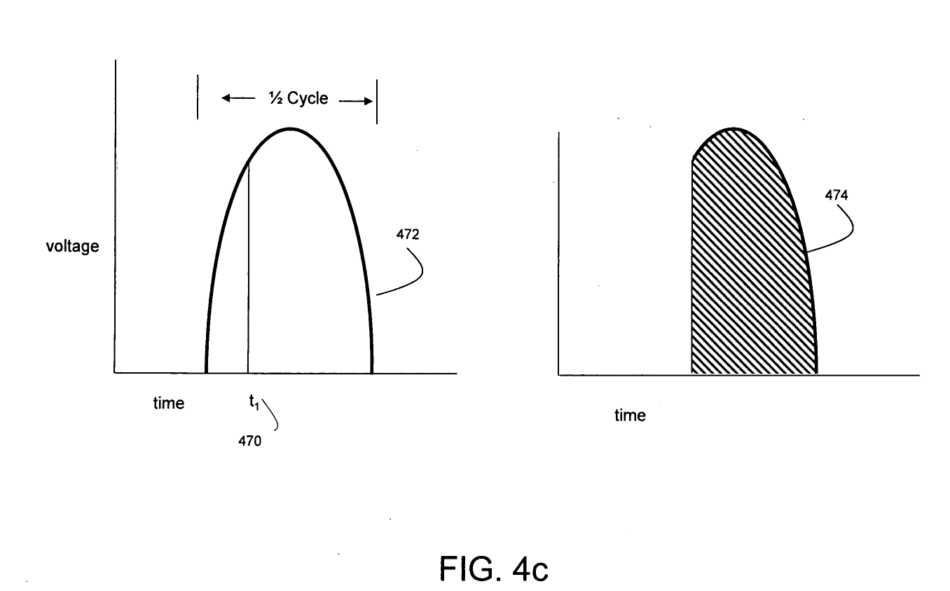

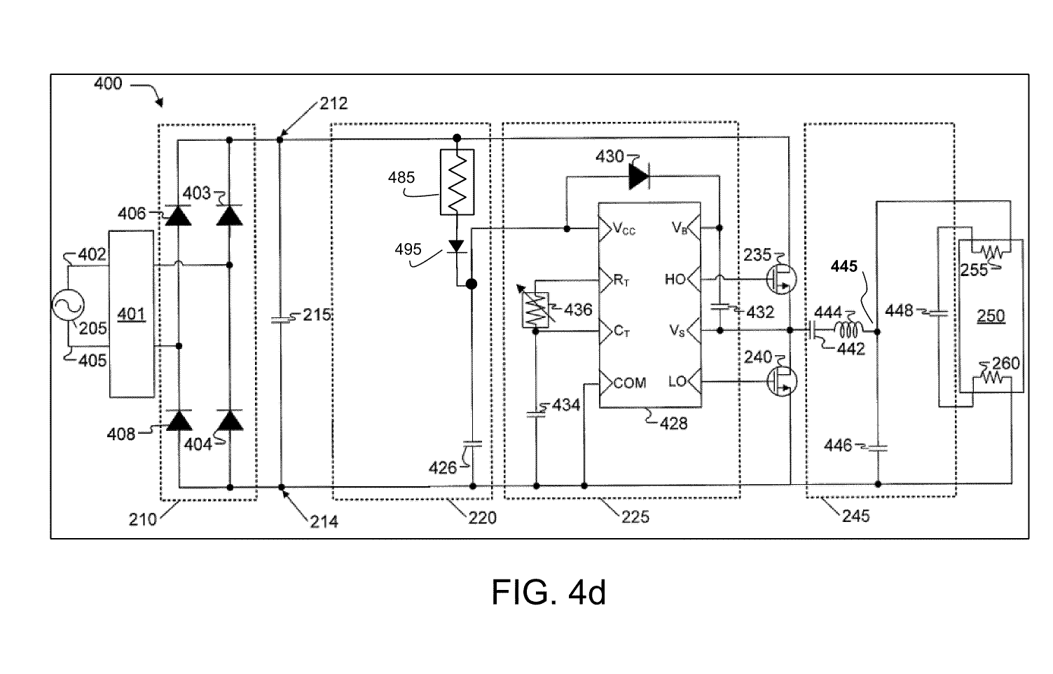

FIG. 4a is a schematic diagram of an exemplary circuit 400 that may implement exemplary process 300 (FIG. 3). In FIG. 4, power source 205 is connected to rectifier 210 via a line filter 401, which insulates power source 205 from noise due (e.g., electromagnetic interference, etc.) generated by the remainder of the ballast circuit. This is discussed in further detail below. More particularly, a first terminal 402 of the power source 205 providing household power is connected to the anode of a diode 403 and the cathode of a diode 404 via the line filter 405. The cathode of the diode 403 is connected to the first node 212 and the anode of the diode 404 is connected to the second node 214. Further, a second terminal 405 of the power source 205 is connected to the anode of a diode 406 and the cathode of a diode 408 via the line filter 405. The cathode of the diode 406 is connected to the first node 212 and the anode of the diode 408 is connected to the second node 214. The first node 212 and the second node 214 are connected via the capacitor 215, which presents a low impedance to high frequency energy.

The value of capacitor 215 is typically a 0.8-1.5 μF polypropylene capacitor for a 23 watt light source, and 0.22 μF for a 5 watt light source. The value can be adjusted as appropriate for the output load, but typically is 4 μF or less for a typical CFL. The value of capacitor 215 is small enough so as to not impact the output rectified voltage at node 212. Specifically, the value should not preclude the output voltage presented at node 212 from dropping down to 15% or less of its peak voltage of the rectifier output at the end of each half cycle. In other words, the voltage at the bottom of the “valley” should be no more than 10-18 volts.

Voltage regulator 220 is also connected to first and second nodes 212 and 214 and is configured to provide a substantially constant output voltage to the driver circuit. In the illustrated example, voltage regulator 220 is implemented using an NMOS transistor 410 that is connected to the first node 212 via a resistor 412. The drain of NMOS transistor 410 is connected to its respective gate via a resistor 414. The gate of NMOS transistor 410 is further connected to a collector of a transistor 416 via an optional resistor 421, which has its respective base connected to the anode of a zener diode 418. Resistor 421 reduces the gain of the transistor thereby reducing possibility of oscillations in transistor 410. The cathode of zener diode 418 is connected to the source of NMOS transistor 410.

In addition, the base of transistor 416 is connected to second node 214 via resistor 420 and its emitter is connected to the second node 214 via a resistor 422. In the example of FIG. 4, the source of the NMOS transistor 410 is connected to the cathode of a diode 424 and the anode of diode 424 is connected to the second node 214 via an energy storage device, such as a capacitor 426, (referred to herein as a housekeeping filter/storage capacitor) which typically has a value of 10-30 μF. As will be described below, capacitor 426 stores energy therein to aid in providing a substantially constant voltage to the driver 225, even in conjunction with operation of a dimmer. The capacitor 426 also is used as a “bootstrap charging capacitor” for assisting diode 430 in charging capacitor 432 discussed below. Thus, capacitor 426 also functions in conjunction with the driver 225, but is shown as a component of regulator 220 for illustration sake.

In the illustrated example of FIG. 4a, driver 225 is implemented using any suitable circuit that selectively actuates transistors 235 and 240. Driver 225 in the exemplary circuit of FIG. 4a includes, for example, an International Rectifier™ 2153, which is a self-oscillating half-bridge driver circuit 428. However, one of ordinary skill in the art would understand that any suitable driver circuit could be implemented to perform the functions that the driver 225 provides (e.g., a 555 timer, processor, or other source of a suitable pulse, including PWM square wave generators, etc.). In other embodiments, transistors 235 and 240 may be integral with the driver circuit 428 (e.g., an integrated circuit such as the STMicroelectronics™ L6574, etc.).

Referring to the driver 225, regulator 220 provides the substantially constant (i.e., regulated) voltage via diode 424, which also isolates voltage regulator 220 from driver 225. Stated differently, diode 424 prevents current from flowing from capacitor 426 into regulator 220 when the voltage of the first node 212 falls below the voltage stored in capacitor 426. In the embodiment of FIG. 4, capacitor 426 and the cathode of diode 424 are also connected to the supply voltage (Vcc) of driver circuit 428 to provide a substantially constant voltage to driver circuit 428. The value of the capacitor may be sized so as to allow operation with a dimmer, such as a phase control dimmer, which may limit the voltage provided to the rectifier, and therefore to the ballast. Thus, even if a dimmer is dimming the input voltage by clamping of the input voltage wave form to the ballast for a certain time period, the capacitor must be sized to provide sufficient power to the driver to allow it to continue to operate through the greatest range of dimming. The capacitor 426 and the cathode of the diode 424 are also connected to the anode of a diode 430, which is connected to the high side floating supply voltage (V_{B}) of the driver circuit 428 via its respective cathode. Further, the cathode of the diode 430 is connected the high side floating supply offset voltage (Vs) of the driver circuit 428 via a capacitor 432 this capacitor supplies the driver power for the switching FET 235.

In the illustrated embodiment of FIG. 4a, the frequency of driver circuit 428 is adjusted by selecting different resistance and capacitance values. More particularly, the oscillating timing capacitor input (C_{T}) on pin 3 of the driver circuit 428 is connected to the second node 214 via a capacitor 434. Further, the oscillator timing resistor input (R_{T}) of the driver circuit 428 is connected to the oscillating timing capacitor input (C_{T}) of the driver circuit 428 via an adjustable resistor 436 or impedance (e.g., a potentiometer, a transistor presenting a variable resistance or impedance, etc.). In such a configuration, the switching frequency of driver circuit 428 can be variably controlled by adjusting the resistance of resistor 436, which is typically set during manufacturing, for example. In other embodiments, a fixed resistance value for resistor 436 can be used.

In the illustrated example, the resistance value of the resistor 436 and the capacitance value of the capacitor 434 configure the driver circuit 428 to produce pulses at a frequency in the range of approximately 20 to 100 KHz. Specifically, the pulses are alternately produced by driver circuit 428 and are output via the high side gate driver output (HO) and the low side gate driver output (LO). Stated differently, during the first half cycle of a period of the switching frequency (i.e., the half of the time period for a single cycle), the high side gate driver output of the driver circuit 428 produces a pulse. During the second half cycle of the period (i.e., the low side of the cycle) of the switching frequency, the low side gate driver output of the driver circuit 428 produces a pulse. Typically, there is a dead time between pulses when neither transistor is turned on, e.g., the time after the first pulse ends and before the second pulse begins.

In the embodiment of FIG. 4a, the high side gate driver output (HO) is further connected to the gate of NMOS transistor 235 and the low side gate driver output (LO) on pin 5 is connected to the gate of NMOS transistor 240. In other examples, driver circuit 428 may be connected to the gates of transistors 235 and 240 via resistors to prevent parasitic oscillations, for example. If the resistors are present, these may be around 31 Ohms. NMOS transistors 235 and 240 are also connected to the high voltage floating supply return (Vs) of the driver circuit 428 via their source and drain, respectively. The drain of NMOS transistor 235 is connected to the first node 212 and the source of NMOS transistor 240 is connected to the second node 214.

As described above, the source of the NMOS transistor 235 and the drain of the NMOS transistor 240 are connected to the resonant or “tank” circuit 245, which selectively stores a charge therein. In the illustrated example, the resonant circuit 245 includes a capacitor 442 in series with an inductor 444. The capacitor 442 functions in part as a DC blocking capacitor. Its value is in some embodiments is 1/10 the value of capacitor 215 as a rough rule of thumb. However, other ratios can be used, but may not be optimized for the power factor. Typically, the capacitor 442 has a value from 1 μF to 0.01μF.

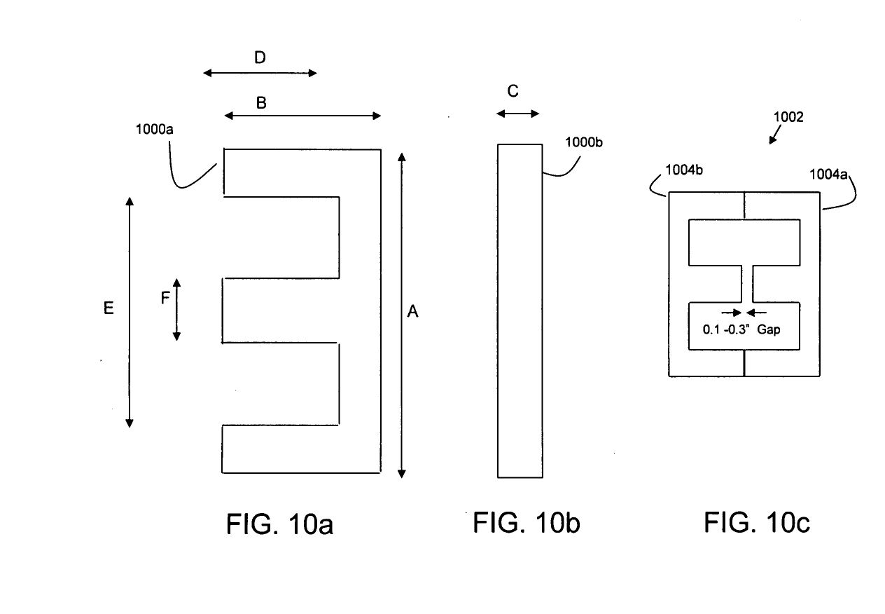

The inductor 444 is generally a gapped core inductor that is capable of handling a large peak current occurring primary at 60 Hz. The choice of the core material of inductor can be selected so as to not saturate the inductor even if a gap is not present. Typically, using conventional ferrite core materials, a gap would be needed to avoid saturation. The inductor is larger than what is used in a typical prior art ballast of the same power, because this inductor processes both the lower line frequency current (e.g., 120 Hz) as well as the higher, switching frequency current (e.g., 20-100 kHz) and must avoid saturation at the lower frequency. This is in contrast to prior art ballasts which process a filtered rectified DC output voltage, resulting in a largely constant DC voltage with little ripple. Hence, the prior art inductors in the tank circuit are not designed to conduct an appreciable amount of current at the line frequency. In FIG. 4a, the inductor stores energy from both the low and high frequency currents. The inductor is gapped so as to reduce the heat caused during operation and to eliminate saturation at peak current of the low frequency current (which can be 3-4 amps, in some embodiments). The size of the gap depends on the permeability of the core material and is typically in a range of 0.1″ to 0.3″, which is much larger than found in a typical prior art ballast. Further, to handle the large current, the wire used is typically “litz” wire (also known as Litzendraht wire), which is wire made from a number of fine, separately-insulated strands specially braided or woven together for reduced skin effect and hence lower resistance to high frequency currents for lower RF losses. The inductor's rating is largely determined by the higher frequency operation and can be sized roughly by the following formula: 30/watts=X mH, where “watts” denotes the output from the light source. The inductor value must be such that it allows the circuit function to operate within the desired frequency range (18-80 kHz) and preferably above 40 kHz in order to meet certain energy efficiency standards. Thus, one rule of thumb is that a 15 watt light source would typically require a 30/15 =2 mH inductor. Further, the value of the inductance varies with the frequency of operation desired according to equation (1) below. Thus, a variety of values can be used which range up to 3 times the resultant inductance or ⅓ of the above result, that is, the range could be as low as ⅔ mH to as high as 6 mH. As the resonant frequency of the tank circuit is increased, the inductance value of the inductor is lowered. FIG. 10a-c shows the dimensions of a portion of a typical inductor core, wherein a side view of the inductor 1000a is shown in FIG. 10a and an end view 1000b is shown in FIG. 10b. The inductor 1002, comprising a “double E” core 1004a, 1004b is shown in FIG. 10c. The following values that could be typically used for a range of power output up to 38 watts at 40 kHz, wherein A=1″, B=0.63″, C=0.25″, D=0.507″, E=0.74″, F=0.25″ and the gap is between 0.1 and 0.3″ but could be as high as 0.5″. Those skilled in the art will recognize that a variety of shapes, wire, material, and configurations are possible in order to meet the functional requirements of the inductor.

The inductor 444 is connected to the second node 214 via a capacitor 446 to store a charge therein and excite the light source. Further, the inductor and capacitors are a small value in relation to 60 Hz, such that they do not change the phase angle of the current relative to the supply voltage, thereby contributing to the high power factor of the circuit. Further still, the inductor 444, which has a small value relative to the prior art, is connected to a capacitor 448 via the first filament 255 and does not have an appreciable reactance at 120 Hz. The capacitor 448 is also connected to the second node 214 via the second filament 260. The capacitor 448 receives current and stores a charge therein to excite the light source via current flowing across the filaments 255 and 260. The resonant frequency of the example resonant circuit 245 is described by equation 1 below:

$${f}_{R} = \frac{1}{2 π \sqrt{\frac{{L}_{444} {C}_{442} ( {C}_{446} + {C}_{448} )}{( {C}_{442} + {C}_{446} + {C}_{448} )}}} \text{:} \qquad Equation [ 1 ]$$

where f_{R} is the resonant frequency of the circuit, L₄₄₄ is the inductance value of the inductor 444, C₄₄₂ is the capacitance value of the capacitor 442, C₄₄₆ is the capacitance value of the capacitor 446, and C₄₄₈ is the capacitance value of the capacitor 448. In the illustrated embodiment, the capacitor 446 is configured to have a different value such that it has a different energy potential than the capacitor 448. In particular, the capacitor 446 provides a larger voltage to allow the lamp 250 (FIG. 2) to turn on. The summation of capacitor 446 and capacitor 448 impacts the resonant frequency of the tank circuit. Typically, the value of capacitor 448 is determined by the desired current flow through the filaments, which have a resistance typically set by the manufacturer or by an industry standards body for a particular country. Typically, capacitor 215, capacitor 442, and capacitor 446 are made from polypropylene, but could be made from polyester, providing each has a low equivalent series resistance (ESR) value. These capacitors typically can not be electrolytic capacitors, because electrolytic capacitors generally have high ESR characteristics at frequencies typically of 40 kHz or higher.

The values of the components in the circuit vary on the output power of the lamp and the desired resonant frequency. In certain embodiments, values for 120VAC operation of certain components are illustrated in the table below:

| | | | | | Inductor | |
|---|---|---|---|---|---|---|
| Em- | | | Capac- | | (typically | |
| bodi- | Output | Capacitor | itor | Capacitor | 0.034 | Freq. |
| ment | Power | 442 | 446 | 448 | litz wire) | (kHz) |
| 1 | 42 W | 0.047 μF | 15 nF | 8.2 nF | .72 mH | 47 |
| 2 | 32 W | 0.1 μF | 37 nF | 15 nF | .901 mH | 27 |
| 3 | 15 W | 0.1 μF | 12 nF | 10 nF | 1.672 mH | 30 |

In embodiment 1 and 3, the operation is for a CFL bulb, whereas embodiment 2 is for a pair of 4 foot tubular lamp bulbs. For embodiments 1, and 2, the inductor can be made from an Elna bobbin part # CPH-E34/14/9-1S-12PD-Z. For embodiment 3, the inductor can be made from an Elna/Fair-Rite core #9478375002. In the above embodiments, it is possible to use a 1 μF capacitor for output powers of 15 -42 watts.

The other values of the circuit shown in FIG. 4a are summarized as follows:

| | |
|---|---|
| Driver 428 | IR Corp IR2153 or IR2153D |
| Transistors 235, 240 | N FET 250 v, 0.47 Ohm |
| Capacitor 215 | 1 μF 250 v, polypropylene |
| Diodes 406, 403, 408, 404, | 1 A, 400 v general purpose diode, 1N4004 |
| 424 | |
| Diode 430 | 1 A, 400 v fast diode, 1NF4004 |
| Transistor 416 | 2N2222 |
| Capacitor 432 | 1 μF 25 v, electrolytic |
| Capacitor 426 | 22 μF 25 v, electrolytic |
| Resistor 412 | 220 Ohm |
| Resistor 414 | 1 M Ohm |
| Resistor 422, 421 | 1k Ohm |
| Diode 418 | 14 v, +/−5%, 200 mW, Zener |
| Resistor 436 | 50k potentiometer |
| Capacitor 434 | 220 pF, mica |

Those skilled in the art will realize that other values or type of components may be used.

The embodiment of FIG. 4a is suitable for operation with a dimmer, due to the presence of the voltage regulator circuit 220. Because the voltage present on node 212 is an unfiltered, rectified AC voltage (e.g., DC), the voltage has a periodic valley of zero volts. A typical half cycle rectified voltage wave form 472 that is present at node 212 is shown in FIG. 4c. At the time that the DC voltage is zero at node 212, the voltage regulator circuit 220 ensures that a stable DC output voltage is nevertheless provided to the driver circuit 225.

When operated with a dimmer, the voltage provided to the ballast circuit may not be that as shown as waveform 472 in FIG. 4c. When operating, a dimmer typically clamps a portion of the waveform to zero for a defined time period. This time period is determined in part by the user turning a potentiometer in the dimmer to effect different dimming levels. Thus, in one instance, the time may be set at t₁ 470 as shown in FIG. 4c. The resulting voltage wave form 474 has the portion prior to t₁clamped to zero, so that the resulting waveform has a period of time where the input supply voltage to the ballast is zero. The shaded portion under the wave 474 represents the energy provided to the ballast, and the less energy provided to the ballast, the less light produced by the light source.

Thus, during the time period up to t₁ the voltage regulator circuit 220 ensures that the driver circuit still receives a DC operating voltage. If, however, the ballast circuit is never used with a dimmer (or the dimmer itself is never used), then the voltage waveform similar to 474 would never occur, and the voltage at node 212 would always look like waveform 472.

In such cases, the voltage regulator circuit 220 can be simplified to the embodiment shown in FIG. 4d. In FIG. 4d the voltage regulator circuit comprises three components, capacitor 426, resistor 485, and diode 495. In this embodiment, the resistor is typically a 47k -90K ohm value and provides a sufficient average voltage to the driver circuit 428. It may be necessary to utilize a version of the driver circuit 428 which has an internal zener diode providing protection from over-voltages as well as using a series diode that is added with the regulated version of the driver circuit. When the voltage at node 212 is less than the required Vcc voltage, the capacitor 426 discharges, providing the necessary voltage to drive the circuit 428. The diode 495 prevents the charge in the capacitor 426 from discharging through resistor 485. This diode is optional, depending on the desired speed of light activation of the bulb. However, in this embodiment, capacitor 426 may not be charged fast enough to provide the necessary voltage when a dimmer is used, due to the clamping of the input voltage by the dimmer. However, this embodiment provides a high power factor ballast which, although not dimmable, provides many benefits.

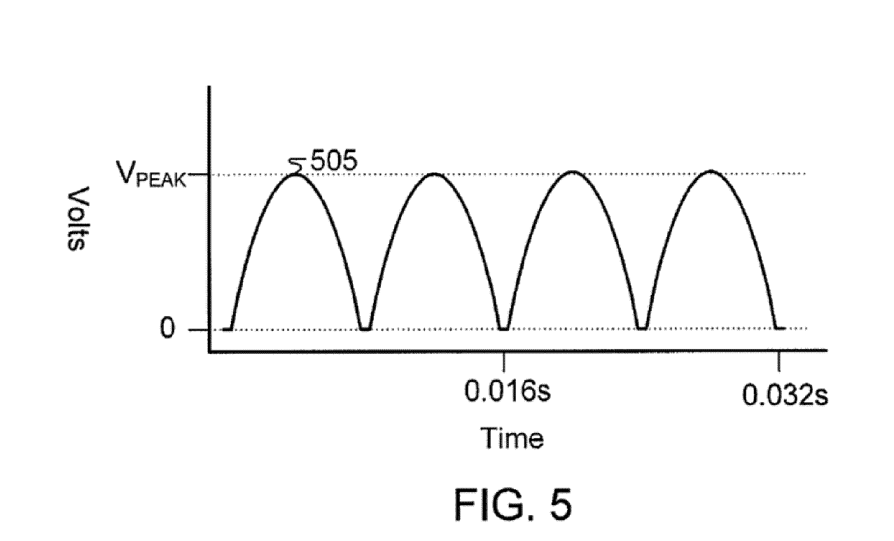

The operation of the example of FIG. 4a will be explained in conjunction with FIGS. 5-9, which illustrate the operation of the circuit 400. As described above, the rectifier circuit 210 rectifies the current provided via the power source 205, thereby creating a voltage waveform at 120 Hz. The exemplary waveform of FIG. 5 illustrates the voltage differential between the first node 212 and the second node 214, which is denoted by the reference numeral 505. As seen, the waveform valleys go to zero or near zero (less than 10-18 volts), because as mentioned previously, capacitor 215 presents a large impedance to the line frequency of the power source 205 and does not substantially affect the rectified alternating current (DC) at the nodes 212 and 214. Consequently, the voltage at node 212 dips from a peak voltage to essentially zero volts each half cycle. The value of capacitor 215 should not significantly impact the low frequency output voltage waveform of the rectifier.

In addition, the line filter 401 is configured to prevent high frequency energy from the capacitor 215 from entering back into the power source 205. The filter 401 is not required to be present in commercial products embodying the invention, but typically a filter circuit of some form is included when the ballast is designed to power 40 watt or higher fluorescent lamps. As shown in FIG. 4b, the line filter may comprise other components, such as a fusible link 464 and a transient suppressor 466 (which although not required for filtering purposes, may be present nevertheless). The filter includes capacitor 462 across in the input mains, and chokes 460a and 460b in series with the input mains. The capacitor is typically 0.1 μF and each choke is typically 190 μH. This line filter attenuates the high frequency signals generated by the ballast from being introduced back into the power source. The transient suppressor is shown as part of the line filter, but it protects transient voltage spikes from the power source. A resistor 465 may be incorporated in addition to the filter 401, which is effective for absorbing energy that may facilitate dimming of the ballast for certain applications. The resistor accomplishes this by reducing the peak current when using certain prior art dimmers and prevents possible blinking of the ballast caused by the ringing due to the line inductance. If the resistor is present, a 3 to 5 ohm, 0.5 watt value may be used for a 10 watt CFL.

Returning to FIG. 4a, the operation of the voltage regulator 220 and resistor 414 causes the NMOS transistor 410 to have a gate-source voltage and, in response, it turns onto conduct current. In the illustrated example, the resistor 412 generally configures the transistor 410 to operate in the safe operating area and in the event of excessive current flow, it experiences a failure thereby uncoupling the transistor 410 from the node 212. Initially, the zener diode 418 conducts current into the base of transistor 416 causing the NMOS transistor 410 to block current from flowing into the second node 214 by presenting a large impedance of transistor 410, which causes the current to flow toward the gate drive supply voltage (Vcc) on pin 1 of the driver circuit 428. When current flows toward the gate drive supply voltage, the capacitor 426 stores the current energy as a voltage to provide a substantially constant voltage to the driver circuit 428. As a result, the driver circuit 428 turns on and produces pulses via its respective outputs at a frequency determined by the resistance value of the adjustable resistor 436 and the capacitance value of the capacitor 434. In some embodiments, the adjustable resistor may be connected to another resistance in series (typically around 33k), to avoid a condition where the adjustable resistor is set to zero (or a very low) resistance, thereby potentially damaging the driver integrated circuit. In other embodiments, the adjustable resistor can be set during manufacturing in order to adapt imprecise component values in the resonant circuit and set the switching frequency of the transistors. In other embodiments, the adjustable resistor 436 can be a fixed value resistor or equivalent depending on the desired operating frequency.

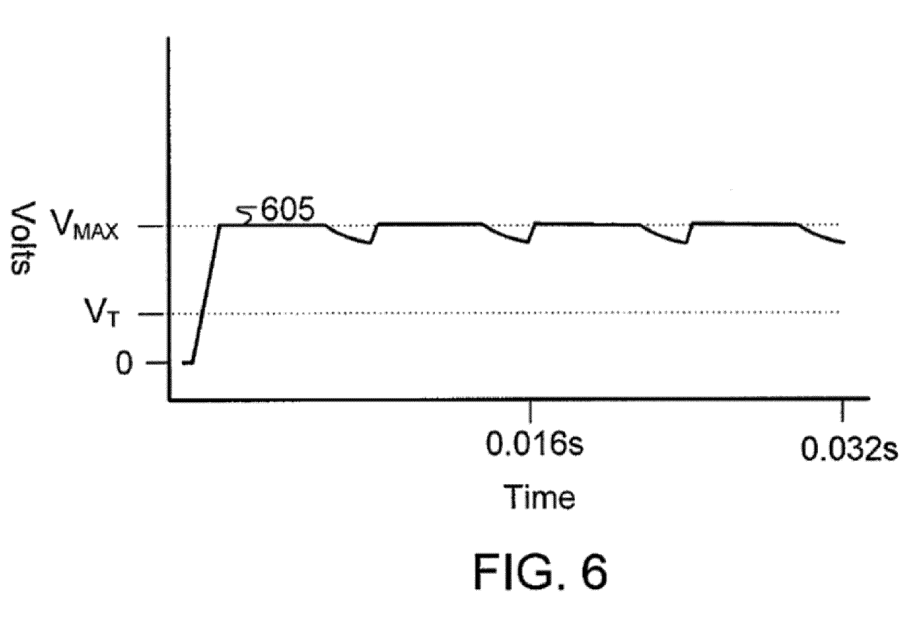

However, when the voltage across the zener diode 418 exceeds a corresponding breakdown voltage (e.g., about −14.0 volts, etc.), the zener diode 418 enters what is commonly referred to as “avalanche breakdown mode” and allows current to flow from its cathode to its anode. In response, the current flows across the resistor 420 and causes the transistor 416 to have a base-emitter voltage (V_{BE}), thereby having a base-emitter current thereby turning on the transistor 416. The transistor 416 sinks current into the second node 214, which reduces the gate-source voltage of the NMOS transistor 410 and the current through the zener diode 418. Once the current in the zener diode 418 does not exceed the design of the output of the regulator value, the zener diode 418 recovers to the design value and reduces the current from flowing into the resistor 420. That is, as illustrated in the example of FIG. 6, by reducing the voltage at the source of the NMOS transistor 410 denoted by reference numeral 605, the voltage supplied to the driver circuit 428 does not substantially exceed the predetermined threshold voltage (Vₘₐₓ). In the example of FIG. 4, the resistance value of the resistor 422 is selected to reduce the loop gain of the transistor 416 to prevent oscillations and the resistance value of the resistor 420 is selected to prevent a leakage current from flowing via the zener diode 418 into the base of transistor 416.

Thus, the example voltage regulator 220 is configured to provide a substantially constant (i.e., regulated) voltage to the driver 225. When the rectified voltage provided via the rectifier 210 falls below a predetermined threshold voltage (V_{T}), the voltage output by the voltage regulator 220 decreases. However, as illustrated in the example of FIG. 6, the energy storage device 426 has a corresponding voltage that exceeds a minimum threshold voltage (V_{T}) and continues to provide energy to the driver circuit 428. In addition, when the voltage at the node 212 falls below the voltage of the regulator 120, the diode 424 prevents current from flowing backwards from the capacitor 426 into the NMOS transistor 410 and resistor 412 from the constantly discharged tank circuit via 212.

The driver circuit 428 is configured to generate a signal that alternately actuates one of the transistors 235 and 240 at the switching frequency, which is much higher than the line frequency. In particular, during the first half (or a portion thereof) of a single cycle of the switching frequency, the high side output (HO) of the driver circuit 428 produces a high side pulse to turn on transistor 235 while transistor 240 is turned off. Typically, the high side pulse has a duration that does not exceed half of the time period of a cycle of the switching frequency. When the driver circuit 428 turns on transistor 235, the transistor 235 couples the node 212 to the resonant circuit 245 via a low impedance path.

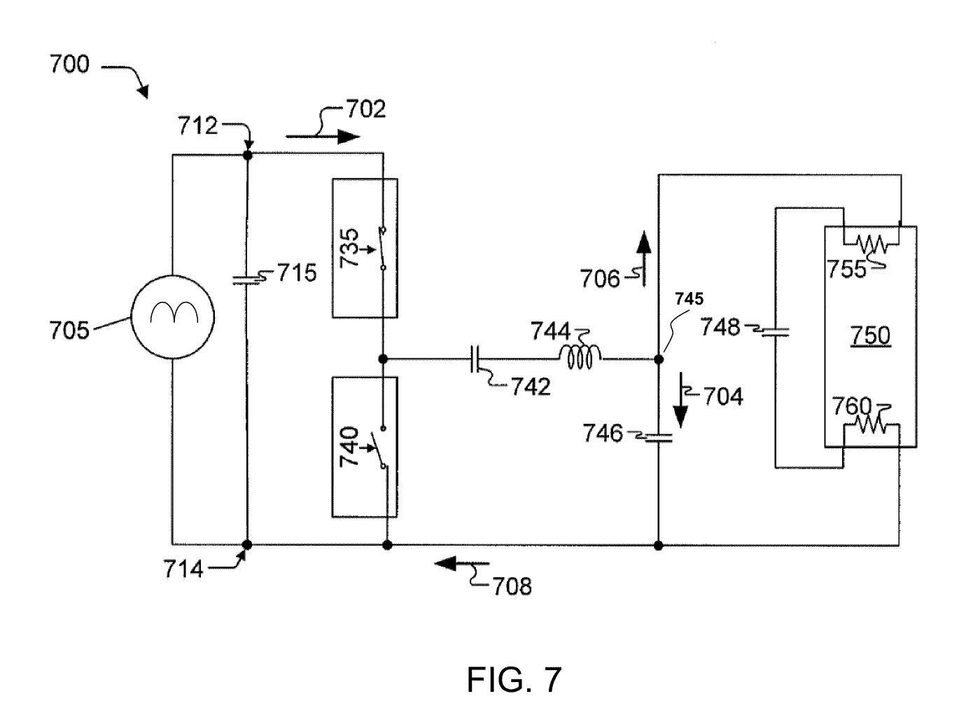

The example of FIG. 7 illustrates an equivalent circuit 700 of a ballast circuit 400 of FIG. 4a. In this illustration, a rectified AC voltage (e.g., a time varying DC voltage waveform where each waveform is half of a sine wave) is represented as an unfiltered rectified power source 705, which produces a waveform similar to that shown in FIG. 5. Initially, energy represented by a current denoted by reference numeral 702 flows from the power source 705 and the capacitor 715 and into the resonant circuit because the transistor 740 is turned off. The current 702 includes both current based on (twice) the line frequency (2*60 Hz=120 Hz) and high frequency current (e.g., 20 kHz) from capacitor 715. In the example of FIG. 7, the capacitor 742 presents a high impedance to the low frequency current, thereby shaping the line frequency current flowing into the inductor 744. As the current leaves the inductor 744, a current denoted by reference numeral 704 having the high frequency current flows into the capacitor 746, which stores a portion of the current as a voltage. In addition, a current having the line frequency current and the high frequency current denoted by reference numeral 706 flows into the filament 755 and a portion of current is stored in capacitor 748 as a voltage. When this process occurs at the beginning of the half cycle of the rectified AC voltage, there is not enough voltage present on the bulb to cause ionization and light to be generated. However, as the input voltage at node 712 increases, and the energy stored in the resonant circuit also increases, the voltage across the light source 750 quickly increases to a point where the voltage is sufficient to initiate ionization and maintain the generation of the light at the light source 750. When this, occurs, then as a result of the line current and the high frequency current in the light source 750, the light source 750 emits a light that is generally visually perceptible. In addition, the line frequency current and a portion of the high frequency current, which are denoted by reference numeral 708 in the illustrated example, leaves the resonant circuit 245 and returns to the power source 705 and capacitor 715. Slightly before the end of the first half cycle at the switching frequency, the energy stored in capacitor 715 is discharged to its lowest level. Because the transistors operate above the tank circuit's resonant frequency, the transistor switches at zero or near zero current levels.

During the second half of the time period of the switching frequency, the low side output (LO) of the driver circuit 428 produces a low side pulse to turn on the transistor 240 just after transistor 235 is turned off. When the driver circuit 428 turns on the transistor 240, the transistor 240 couples the node 214 to the resonant circuit 245 via a low impedance path. The second pulse generally has a duration that is less than 50% of the time period of the switching frequency (e.g., less than a half-cycle).

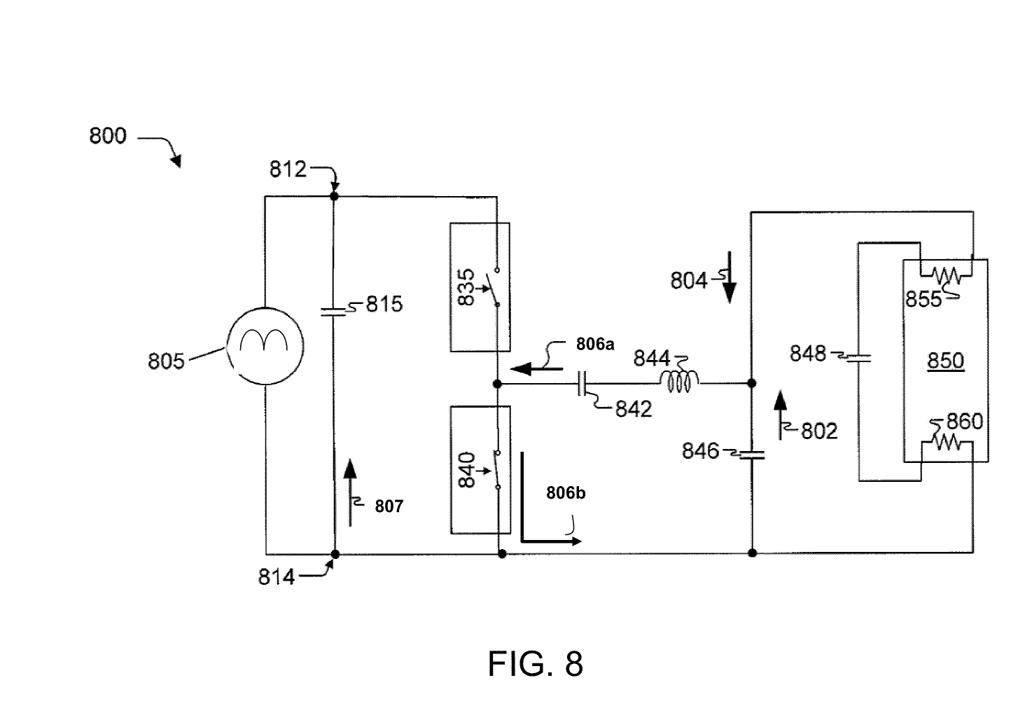

The example of FIG. 8 illustrates an equivalent circuit 800 of the ballast circuit 400 (FIG. 4) when the switch 840 is closed. Two simultaneous events are occurring. First, a low frequency current 807 is continuously charging capacitor 815. Recall that capacitor 815 is discharged to its lowest point after switch 835 has closed. After switch 835 is opened, capacitor 815 is no longer discharging, and is recharged by the unfiltered rectified voltage from source 805. Second, when switch 840 is closed, there is no current flowing and no energy stored in the inductor. Once switch 840 is closed, the capacitors in the resonant circuit discharge, generating a current. The flow of current 806a when the transistor 840 couples the node 814 to the resonant circuit is the sum of the currents 802 and 804 (which is from the charge in capacitors 846 and 848). Capacitor 842 stores an additional charge compared to capacitors 846 and 848 based on the low frequency current which previously flowed through it, that is not clamped by the bulb. Current 806a flows through the switch 840 back into the resonant circuit as shown by 806b. Thus, the energy in the resonant circuit is recirculated. At the same time, the voltage across the inductor and capacitors 846 and 848 changes polarity, and this causes the voltage across the light source 750 to experience a negative “mirror” of the voltage present in the prior switching half cycle.

As described above, by turning on the transistor 840, the resonant circuit is connected to the second node 814 via a low impedance path. In response, the capacitors 842, 846 and 848 discharge the voltage therein as currents denoted by reference numerals 806a, 802 and 804, respectively. The currents 802 and 804 flow into the inductor 844 and charge the capacitor 842 as a voltage, thereby causing the resonant circuit 245 to have a negative voltage with respect to the second node 814. As a result of current leaving the capacitors 846 and 848, the light source 850 is actuated to visually emit light. After a delay, the capacitor 842 discharges producing a current as denoted by reference numeral 806, which flows into the node 814. At the end of the second half cycle of the carrier frequency, the resonant circuit stores substantially no energy and all the energy is stored in the inductor, with very little, if any, current flowing. Thus, the driver circuit is continually driving switches 835 and 840 even when there is no current flowing through the switches.

Thus, in FIG. 7, when switch 735 is closed, the resonant circuit is energized both from the line voltage (unfiltered DC voltage) and the small energy in capacitor 715, which is added to the energy already stored in the resonant circuit. Then, in the next half of the switching cycle, in FIG. 8, switch 835 is opened, and switched 840 is closed. The capacitors in the resonant circuit discharge, causing the voltage to become negative across the bulb. Assuming the bulb has been ionized, the bulb functions as a voltage regulator to limit the maximum absolute voltage that can exist across its terminals. During bulb ionization, current 802 is largely constant, and current 804 is varying with the AC input line current. It should be noted that this description is in terms of a single switching cycle at a high frequency, and that the process is repeated for other switching cycles wherein the input voltage from the power source may be at a lower or higher voltage, thereby impacting the relative charges, voltages, and currents of the various elements in the circuit.

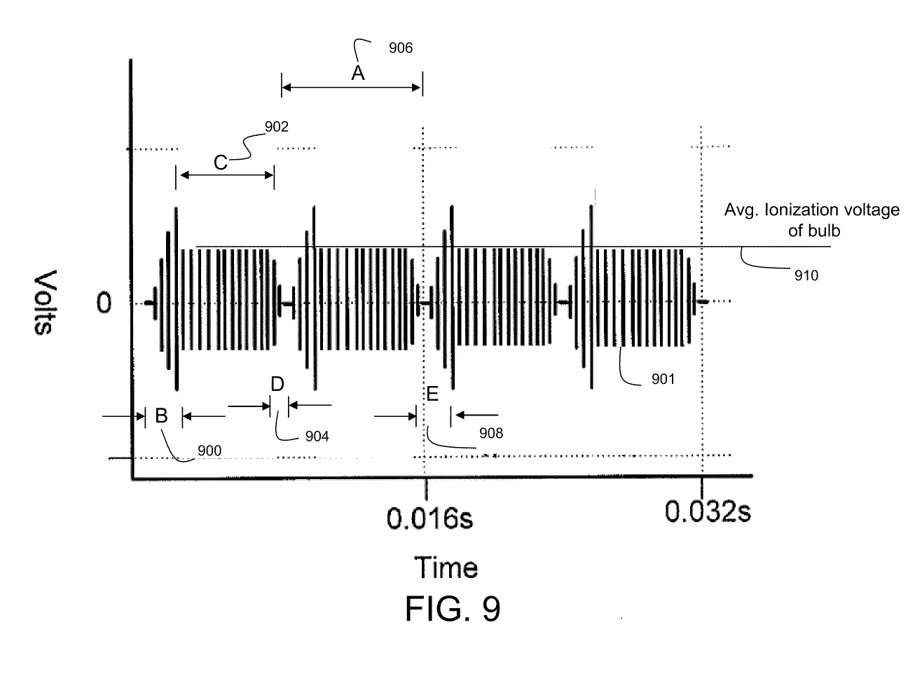

The illustrated voltage waveform of FIG. 9 illustrates the voltage in the resonant circuit across the light source during operation. FIG. 9 illustrates a number of half line cycles (120 Hz), wherein a given half cycle A 906 is half the line frequency (e.g., 120 Hz or 0.008 seconds). At this time scale shown in FIG. 9, the individual voltages 901 at the switching frequency (e.g., 40 kHz) are difficult to identify individually, and the figure is not necessarily drawn to scale. (If drawn to scale, the high switching frequency waveforms would be indistinguishable).

Each half line cycle in time period A 906 shows a similar pattern. In time period B 900, which occurs at the beginning of the half cycle, the switch 735 of FIG. 7 introduces energy from the rectified AC line. However, because the rectified AC voltage is just increasing from zero volts, the energy introduced into the resonant circuit is relatively small. Further, any energy stored in bypass capacitor 715 is added as well into the resonant circuit. The energy is stored as a voltage in the capacitors of the resonant circuit. Because of the cumulative aspect of energy stored in resonant circuit, the voltage across the light source increases faster than the increase in the rectified AC voltage. Then switch 735 opens, and shortly thereafter switch 740 closed, which is depicted in FIG. 8. At this point, the energy is converted into the inductor from the capacitors and back into the capacitors at a reversed polarity and the voltage across the bulb is reversed. During a short time period B 900 in FIG. 9, the voltage rapidly increases in the unloaded resonant circuit because the tube has not ionized. No ionization occurs in the tube, and while there may be some continued light generated by phosphoresce in the tube, there is no active ionization occurring to generate light.

This process builds up voltage across the tube until ionization occurs (around 20-35 volts of the input voltage to the resonant circuit), which occurs at the beginning of time period C 902. The tube acts as a voltage clamping regulator to keep the voltage constant across it (that is, the magnitude or absolute value of the voltage, recognizing it is either positive or negative in value), which is shown as an average ionization voltage level 910 in FIG. 9. This process continues for much of the remainder of the half-cycle, until the unfiltered DC input voltage to the resonant circuit decreases below a point where ionization is no longer maintained. This is shown as time period D 904. Thus, before ionization, all the energy in the resonant circuit is circulated, and after ionization, most of the energy in the resonant circuit is circulated (because a portion is transferred to the bulb for generating light).

The voltage change over the beginning, peak and falling voltage edges of the rectified AC input to the tank (which is switched by transistors 735 and 740) and the constant ionization voltage of the bulb causes a large change in current to be linearly processed by capacitor 742 and inductor 744. As compared to a traditional ballast with a filtered DC supply, this change in current causes a large change in Q.

Thus, there is short time period at the beginning of a half cycle and the end of the half cycle shown as period E 908, where ionization does not occur in the tube, and there is no light generated as a result of ionization. Consequently, unlike the prior art which initiates ionization in the tube and maintains the ionization during normal operation (e.g., while power is applied to the ballast), the present invention causes ionization to initiate every half cycle, or 120 time per second. Further, there is a time period every half cycle where light due to ionization stops and is not generated. However, the time period when the voltage is too low to generate ionization is very short, and does not create a perceptible condition for humans.

The current flowing into the resonant circuit at the line frequency is largely maintained as a sine wave, which means that the current load is largely in phase with the voltage at the line frequency from the power source. Further, the resonant circuit does not store any significant energy (inductive or capacitive) to distort the low frequency current during the time period between the half cycles, thereby causing the resonant circuit to appear as a resistive load to the power supply. Thus, the present circuit maintains a high power factor during operation. In particular, because the current flowing through the resonant circuit is substantially similar to a sine wave, the crest factor of the illustrated example is approximately the square root of 2 (e.g., about 1.5), which close to an ideal crest factor. Contrast this to the prior art ballasts which require a dedicated power factor correction circuit to obtain a suitable crest factor.

In addition, the example ballast circuit of present invention does not require nor uses a large, high voltage electrolytic capacitor as used in conventional ballasts to store substantial amounts of low frequency energy because the high frequency energy is continually recycled by a non-electrolytic bypass capacitor. Further, the impedance presented to the power source 205 is modified only by the resonant circuit and the example circuit 400 contains only a single inductor. As a result, the embodiments described herein are able to realize a high power factor (typically above 0.9) with a single stage of processing with respect to the power source without incorporating the components found in a traditional power factor correction circuit. In addition, because the described examples do not require a large, high voltage, low temperature electrolytic capacitor, the lifespan of ballasts of the present invention is substantially increased.

Other benefits of the invention include the ability to effectively dim the light source over a predictable and wider range. Although the ballast itself does not provide any dimming and requires interaction with a dimmer circuit to do so, the ballast circuit can be effectively used with the dimmer disclosed in U.S. patent application Ser. 12/205,564 filed on Sep. 5, 2008, which in turn claims the benefit under 35 U.S.C. §119(e) to U.S. Provisional Patent Application entitled “Two-Wire Dimmer Switch for Dimmable Fluorescent Lights” filed on Feb. 8, 2008, bearing Ser. No. 61/006,967, both of which are herein incorporated by reference for all that each teaches. The charging of the housekeeping electrolytic capacitor in the voltage regulator is performed at the very beginning of the voltage waveform produced from the output from the dimmer which dissipates the stored inductance in the house wiring created when the phase controlled dimmer has turned on charging the input bypass capacitor of the ballast. This would normally cause a ringing of current of the input bypass capacitor if it were not damped by the load presented by the series regulator at this precise time during the charging of the house keeping capacitor.

The aforementioned ballast circuitry can be adapted in another variation for providing power to a fluorescent lamp in a cold cathode fluorescent lamp (CCFL) configuration or mode of operation. This arrangement can be used for a variety of fluorescent lamp types, including compact fluorescent lamps (“CFLs”), linear tubular (removable) lamps, and tubular arrangements of other shapes. Advantageously, this arrangement can be used with an integrated lamp and ballast combination, such as a CFL.

CCFLs do not rely on a filament to be heated when started (nor in normal operating mode). Pre-heating is used to reduce the required ionization voltage of lamps using filaments. Thus, the initial voltage needed to ionize the tube in a CCFL mode of operation is typically higher relative to ballasts that power filaments in the fluorescent lamp. However, fluorescent lamps that rely on a filament are typically not as efficient because the heat in the filaments does not generate light. Further, the operation of a bulb can be adversely impacted if a filament is broken or degraded in some manner. Further, filaments represent an additional component cost and manufacturing cost to the lamp. While the required starting voltage to initiate ionization in a CCFL configuration is higher than a lamp using filaments, ionization occurs faster in the present invention during initial startup because in part there are no filaments to heat. In the CCFL configuration, a high voltage sufficient to cause ionization is applied to the ends of the tube. Because the tank circuit provides the required ionization voltage very quickly, the bulb quickly ionizes. Once ignited, the tube presents a lower impedance (e.g., negative value) and thus a ballast is required to limit the current. This is true regardless of whether filaments are used. Once ignited, there is no significant difference in the voltage required to maintain ionization in a lamp having filaments as compared to a lamp without filaments.

It is possible to also operate a fluorescent bulb having filaments in a CCFL configuration, i.e., without heating the filaments. In this configuration, the ends of the filaments can be simply shorted together, and they are not relied upon for starting the lamp. In other embodiments, only one terminal of each filament may be connected to the tank circuit, with the other terminal of each filament not connected. From an electrical perspective, shorting the filaments can be considered equivalent to removing the filaments because the filament resistance is reduced to zero. Hence, the present invention can be adapted to function with conventional four-pin fluorescent bulbs, as well as two-pin linear bulbs. Consequently, a “CCFL” bulb as used herein refers to a bulb used in a cold cathode mode—e.g., there is no filament in a bulb that is heated. Thus, a CCFL may have a filament, but if present, it is not heated. The present invention can also be adapted to CFLs having integrated ballasts, and avoids the need for incorporating filaments in the bulbs of CFLs. This reduces component cost and manufacturing complexity.

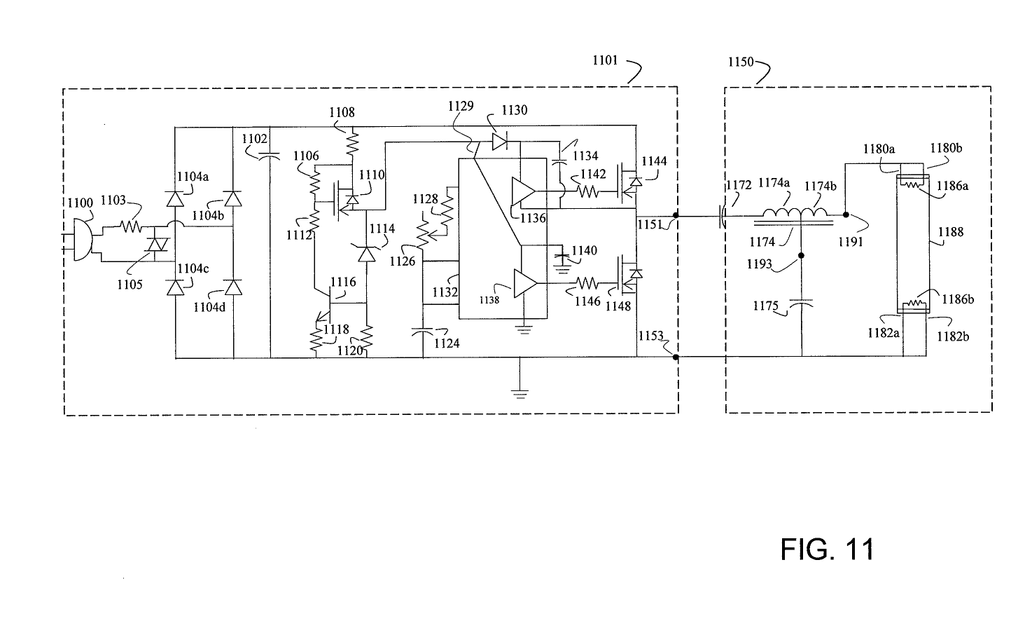

FIG. 11 illustrates one embodiment of the present invention used in a CCFL configuration. This embodiment is designed for an input line voltage at 120 VAC, 60 Hz operation, unless noted otherwise. Those skilled in the art can readily adapt the circuit for other voltages/frequencies. In FIG. 11, the ballast portion 1101 is the same as described earlier, and hence its description is not repeated again. The value of the bypass capacitor 1102 is in the range previously disclosed (generally under 1 μF) as appropriate for the particular load of the fluorescent lamp. Its value does not appreciably distort or modify the rectified voltage from the full wave bridge rectifier. The scope of “distort” or “modify” means that the rectified voltage waveform is not precluded from having valleys at each half-cycle where the rectified input voltage drops to 50% or less of the peak input voltage. In other words, if the valley on the input line voltage waveform (see, e.g., FIG. 1e) does not drop down to at least 50% of the peak voltage, then the capacitor value is too large, and distorts the rectified AC input voltage. The ballast portion 1101 connects with a tank circuit 1150 at input nodes 1151 and 1153.

However, the tank circuit is different compared to previous embodiments and the tank circuit 1150 comprises capacitors 1172 and 1175, an inductor 1174, and lamp 1188. In this embodiment, lamp 1188 is illustrated as having two filaments 1186a and 1186b (e.g., a four-pin gas discharge tube), but each filament has its corresponding leads (1180a, 1180b, and 1182a, 1182b) connected together. Thus, the potential across each filament is zero volts. In other embodiments, a two-pin, filament-less tube can be used. The use of the bulb with filaments in FIG. 11 is merely to illustrate that filament type bulbs can be used, and does not imply that only lamps with filaments must be used. Further, in other embodiments, only one lead of each filament may be connected, but again, in this configuration the filament is not heated to facilitate startup.

In this embodiment, the inductor 1174 is configured as a tapped inductor. One portion 1174a (to the left of the tap) comprises about half of the total inductance and the other portion 1174b (to the right of the tap) comprises the other half. From an implementation perspective, the first portion comprises about ¾ of the total number of windings and the second portion comprises about ¼ of the number of windings. This demarcation point occurs typically at a center tap of the inductance value (not a center tap of the number of turns). These portions will be referred to herein as the “right portion” 1174b and “left portion” 1174a, and is merely convenient nomenclature to illustrate the invention in light of FIG. 11. This should not be interpreted as limiting the configuration or location of the inductor or portions thereof in a physical embodiment. Further, the ratio of turns on the right portion is not limited to 25%, but can be in a range typically from 10% to 40%. Further, even this range can be exceeded, but operation becomes less than optimum.

The two windings on the inductor are mutually electromagnetically coupled so as to create an interaction, a so-called ‘transformer action.’ Thus, the inductor can also be viewed as acting as a transformer (e.g., an “autotransformer”). The use of a tapped inductor can be viewed as functionally equivalent to a transformer having a specified inductance on the primary winding. Thus, it may be possible to implement the aforementioned tank circuit using components other than a tapped inductor, but which function equivalent to the tapped inductor.

The tap is connected to node 1193, so that a resonant circuit is formed from node 1151, through capacitor 1172, the left portion of inductor 1174a, to node 1193, and then to node 1153. This portion forms an LC circuit that resonates having a sinusoidal voltage when a square wave—like voltage is provided to the inputs of the tank circuit from the ballast portion 1101. The portion of the inductor to the right of the tap 1174b does not contribute its inductance to the resonant circuit. Specifically, because node 1193 is tapped within the inductor, the right side inductance of the right portion 1174b of inductor 1174 is not used to determine the L value in the resonant circuit.

The inductance associated with the left portion of the inductor, along with the capacitor 1172, determines the resonance of the tank circuit. Thus, the inductor 1174 can be viewed as having a transformer action with respect to generating a voltage for the bulb, but also as having an inductance value for purposes of determining the resonance of the tank circuit.

The inductor value 1174a should be selected (along with the capacitor value of capacitor 1175) so that the resonant frequency of the tank circuit is less than the frequency of the incoming alternating voltage at nodes 1151 and 1153. Further, the value of the inductance of the entire inductor should be such that the inductor operates in a non-saturated or a limited saturated mode of operation. This can be accomplished by use of an inductor using certain materials, core size, and gapping to produce the appropriate inductance value as previously disclosed. Specifically, the presence of a 60 Hz rectified sinusoidal component in the input voltage at nodes 1151 and 1153 should result in no or limited saturation of the inductor. Avoiding saturation of the inductor requires using a typically larger inductor in the tank circuit than is found in the tank circuits of the prior art.

In this embodiment, capacitor 1172 in conjunction with capacitor 1175 determines the total capacitance of the tank circuit, and therefore determines the resonance frequency of the tank circuit (obviously, the inductance value of the inductor also plays a part in determining the resonance frequency). However, the capacitance of the tank resonant circuit is largely determined by the capacitor 1175 as it is smaller in value. Capacitor 1172 also acts as a DC blocking capacitor and removes any DC component in the input square wave provided to the tank circuit by ballast portion 1101. This capacitor ensures a symmetrical (balanced) current is provided to the lamp. Thus, capacitor 1172 electrically isolates the inductor and the bulb from the DC component in the input voltage waveform. Further, capacitor 1172 also limits the current that would otherwise saturate the inductor from the rectified power line frequency (e.g., 120 Hz) present on the input voltage waveform.

Capacitor 1175 is also part of the resonant circuit and is present between node 1193 and node 1153. Capacitor's 1175 main purpose is to act as a resonant capacitor for the inductor in the resonant circuit. In this embodiment, the tank circuit can be viewed as having an LC resonant circuit within it, with a portion of the tapped inductor (e.g., the right side) that is outside the resonant circuit, but still part of the tank circuit. Capacitor 1175 also adjusts for any voltage imbalance in the lamp.

In one embodiment of the invention corresponding to FIG. 11, the values of the components are as follows: left-side portion of the inductor 1174a has an inductance of 1.1 mH, the right side portion of the inductor 1174b is about 0.9 mH (providing a total of 2 mH), capacitor is 12372 is 12 nF, and capacitor 1172 is 0.047 μF or less.

When the tank circuit resonates, the voltage across nodes 1191 and 1153 increases and is presented to the ends of the lamp 1188. Although these nodes are attached to the filaments, the presence of the filaments is insignificant to the analysis of the circuit, because they are connected together. The voltage across the lamp is based on the whole of inductor 1174, not just a portion of it. In other words, even though inductor portion 1174a is in the resonating portion of the tank circuit (and inductor portion 1174b is not), the voltage generated and presented to the lamp is based on both inductor portions 1174a, 1174b. Thus, the voltage is “boosted” by the second set of windings (and hence, these windings may be referred to as “boost windings” or as a “tertiary winding”). The presence of the additional inductor portion 1174b results in a higher voltage to the lamp than what is generated at the tap (which is node 1193). Thus, the right side portion of the inductor 1174b creates an added voltage to the voltage produced at node 1193. This added voltage is designed so that it is sufficient to initiate ionization. The peak voltage at node 1193 (which is the inductor tap) is less (by approximately by 25%-33%, which is the ratio of the windings for 1174b) than the peak voltage at node 1191 during the ramp-up leading to ionization. The voltage generated by the tank circuit and supplied to the bulb results the energy in the inductor being ‘pushed’ into the lamp. Further, the transformer action of the tapped inductor reduces the peak current through the bulb caused by the low frequency voltage (e.g., 120 Hz) compared to other embodiments previously described (e.g., non-CCFL mode of operation).

Once ionization occurs, the voltage across the lamp is reduced. Recall that the nature of an ionized lamp is that it clamps or limits an applied voltage. Thus, once ionized, the voltage across the lamp will not exceed a certain value (depending on the lamp and other factors) and this clamps the voltage at node 1191 to typically around 100 volts. During ionization, the peak voltage at node 1193 (which is the inductor tap) is less (by approximately by 25%-33%, which is the ratio of the windings for 1174b) than the peak voltage at node 1191.

When the bulb ionizes, the bulb forces a reduction in voltage that causes a current surge from the tube. Because the inductor portion 1174b is in series with the current passing through the lamp, the inductor portion 1174b serves to limit the rate of change of current flowing through the lamp. There is a leakage inductance associated with the inductor 1174b, that limits the current. The leakage inductance could be modeled as a separate inductor in series with the inductor, and which is represented as being part of inductor 1174b in FIG. 11. Inductor portion 1174b therefore limits rapid changes of current through the lamp at the time ionization, and this contributes to the longevity of the lamp.

Unlike prior art systems, capacitor 1175 does not discharge as much energy through the lamp at high voltage. The peak voltage across the capacitor at node 1193 is lower than the peak voltage at node 1191, which is the voltage across the lamp. Thus, the capacitor typically discharges 30-60% less energy than prior art ballasts having a capacitor across the lamp. Thus, the voltage across capacitor 1175 peaks typically around 67-70 volts for 120 VAC operating, and is typically less than the 80-100 volts at node 1191, which is the voltage after ionization of the lamp.

Although the bulb is ionized each half cycle of the line power input frequency, the presence of the inductor portion 1174b and capacitor 1175 aid in the longevity of the bulb. First, the inductor portion 1174b ‘cushions’ the current generated by the bulb during ionization by limiting the rate of change (di/dt) of the current, and second, the two-part inductor results in a lower voltage at node 1193, which is the voltage across capacitor 1175. When capacitor 1175 discharges, it does so at a lower voltage and energy level compared to the prior art. In other words, the presence of the boost windings of 1174b increase the voltage to the bulb, and requires less current in the tank to reach the ionization voltage. Hence, capacitor 1175 is smaller, and is required to discharge less energy by the bulb during initial ionization. This may allows use of smaller and less expensive capacitors.

The tank circuit of FIG. 11 provides other benefits. First, there are typically fewer parts in the tank circuit compared to the prior art. In FIG. 11, only two capacitors and a tapped inductor are used in addition to the bulb. Because filaments are not used to facilitate ionization, the possibility of broken or degraded filaments hampering starting is not a factor and the ballast can be adapted to operate with bulbs either having filaments or not. Further, because there are no filaments to heat, which takes a few milliseconds or more, ionization occurs faster at initial startup. Specifically, as soon as the voltage across node 1191 exceeds the ionization level, the bulb ionizes. Typically, this occurs twice as fast than if filaments are heated. Also, the average voltage across capacitor 1175 is not as great as the average voltage across the lamp during operation (and is in fact, about 30% less due to the voltage contributed by the transformer action of the tapped inductor). Because the voltage on the capacitor when the lamp ionizes is less than the voltage across lamp, there is less charge to be dissipated out of the capacitor into the lamp. This contributes to the longevity of the bulb. Further, the leakage inductance present in the tapped inductor limits the peak current from the discharge of the capacitor 1175 in the tube during ionization at each half-cycle which also thought to aid in the longevity of the bulb.

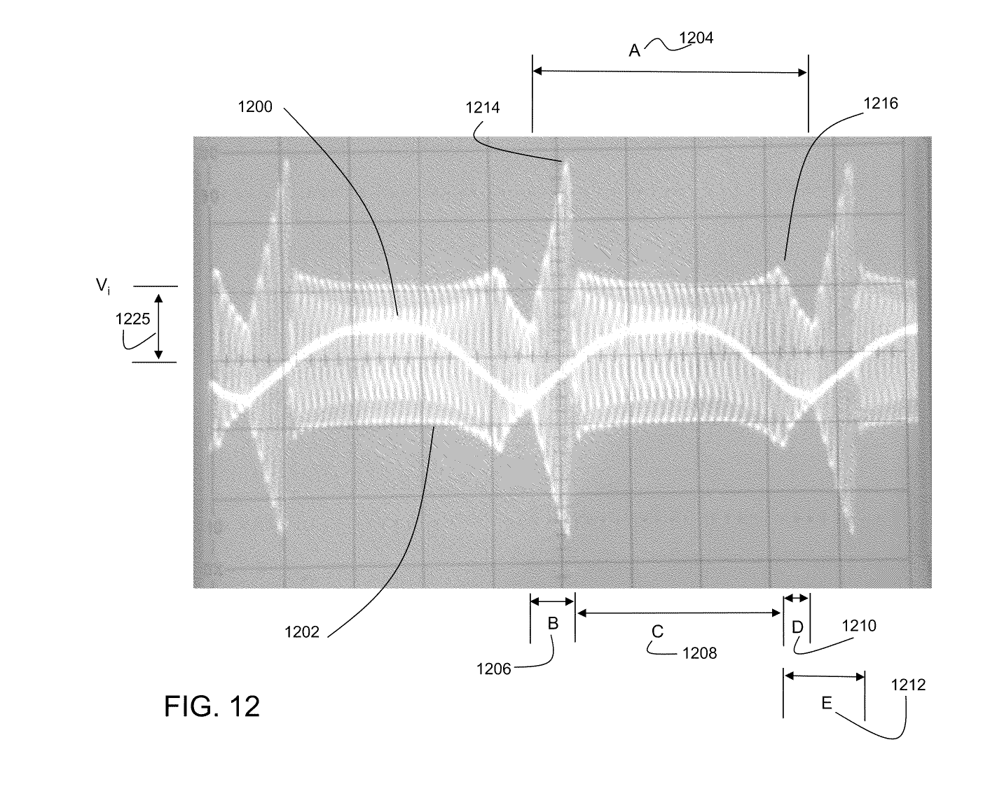

In this embodiment, the lamp is re-ionized every 1/120 of a second, which is every half cycle of the input power frequency (at 60 Hz). The voltage waveform across the lamp is illustrated in FIG. 12. In FIG. 12, the rectified AC voltage 1200 is illustrated as a rectified sine wave having a peak of around 160 volts and a period of 1/120 of the line input frequency. The 1/120 time period represents a half cycle, which is twice the line frequency of the input voltage. This pattern is repeated every half cycle of the input voltage frequency and one example of the half cycle is shown as Time Period A 1204. Further, Time Period A 1204 is also illustrates another instance of the repeating high frequency voltage waveform 1202 across the ends of the bulb.

The time leading up to ionization is illustrated as Time Period B 1206. In the tank circuit embodiment of FIG. 11, the time period leading up to ionization occurs faster than in non-CCFL configurations because of the presence of the inductor boost windings which provide an additional voltage boost. Thus, the corresponding time period for ionizing the CCFL bulb is less as the voltage in the tank circuit as shown in FIG. 12 during Time Period B builds up rapidly. The curved envelope of the high frequency voltage buildup during Time Period B reflects the sine wave voltage 1200 during the same time.

Once the voltage at the bulb reaches an ionization level 1214, the bulb ionizes, and clamps the voltage to a lower level (typically around 100 volts), shown as the ionization voltage Vᵢ 1225. The time period of ionization is illustrated as Time Period C 1208. During this time, light is being generated by the lamp.

Eventually, the AC voltage continues to drop and tank circuit is no longer able to sustain ionization, and Time Period D 1210 is entered. This time period reflects that ionization of the bulb is no longer maintained, and the tank voltage begins to drop.

The transformer action of tapped inductor 1174 provides a brief current flow to the tank circuit at the end of ionization, thereby extending the time which the bulb is ionized. Consequently, with both the ionization Time Period B 1206 and the discharge Time Period D 1210 shortened relative to non-CCFL embodiments, the time period of ionization (Time Period C 1208) is longer. Because the ionization period is longer, the CCFL embodiment generates light longer than without the tapped inductor.

Further, during Time Period D, the residual energy in the tank diminishes, but does not completely dissipate before the next half cycle begins. Thus, the lamp voltage typically does not reach zero volts during the ‘non-ionization time’ (Time Period E 1212). The non-ionization time is the time which the bulb is not ionized, and comprises Time Period B and Time Period D. Although the bulb may not be ionized, that does not necessarily mean that light is not being generated from the bulb. A typical fluorescent bulb comprises a phosphorous coating which persists in generating light. Thus, it is not obvious from FIG. 12 if, or when, light is no longer being generated by the bulb during the period of non-ionization.

Although the tank circuit 1150 can be used with other ballast designs, using the tank circuit with the ballast portion 1101 results in a highly efficient ballast, having a high power factor with long bulb life. The presence of the bypass capacitor 1102 (which is selected to be suitable with the load of the lamp) aids in achieving a high power factor, and the presence of resistor 1103 (around 3-5 ohms) reduces noise when the ballast is operated with prior art dimmer circuits and which may be necessary to function with prior art dimmers. The operation of the ballast can be combined with the dimmer circuit as disclosed in U.S. patent application Ser. No. 12/353,551, filed on Jan. 14, 2009, entitled Method and Apparatus for Dimming Light Sources, the content of which is incorporated herein by reference. When the dimmer circuitry is combined with the ballast 1101 and tank circuit 1150, the combination provides a highly efficient, high power factor, long lasting lighting system that is also dimmable.

The dimmer acts to limit the incoming power to the ballast by modifying each half cycle of power to the ballast. The dimmer circuit can be viewed as “slicing off” or controlling the phase angle of the input power for a portion of the input power half cycle as shown in FIG. 4c. During the portion of the input power cycle when power is applied (e.g., the portion that is not sliced, e.g., portion 474 in FIG. 4c), the bulb is ionized for that portion of the cycle and then ends ionization at the end of the half-cycle. Thus, the effect of dimming increases the non-ionization time.

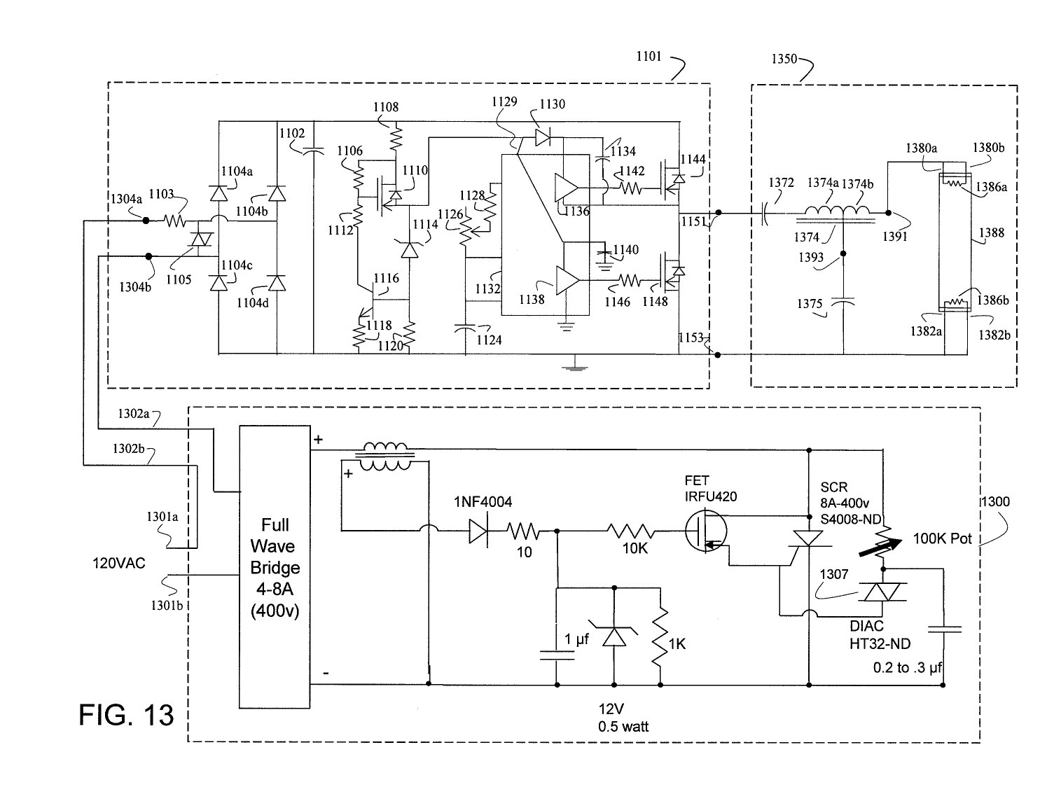

The circuit diagram of the ballast 1105 connected to a dimmer is shown in FIG. 13. In FIG. 13, the dimmer circuit 1300 receives 120 VAC from a household power at inputs 1301a, 1302b. The remainder of the circuit 1300 operates as discussed in the aforementioned patent application. The outputs 1302a and 1302b from the dimmer circuit are the modified power voltage which is provided to the inputs of the ballast circuit at nodes 1304a and 1304b. Thus, the ballast is configured to the voltage waveform from the dimmer as illustrated in FIG. 4c, subject to the dimmer being set appropriately.

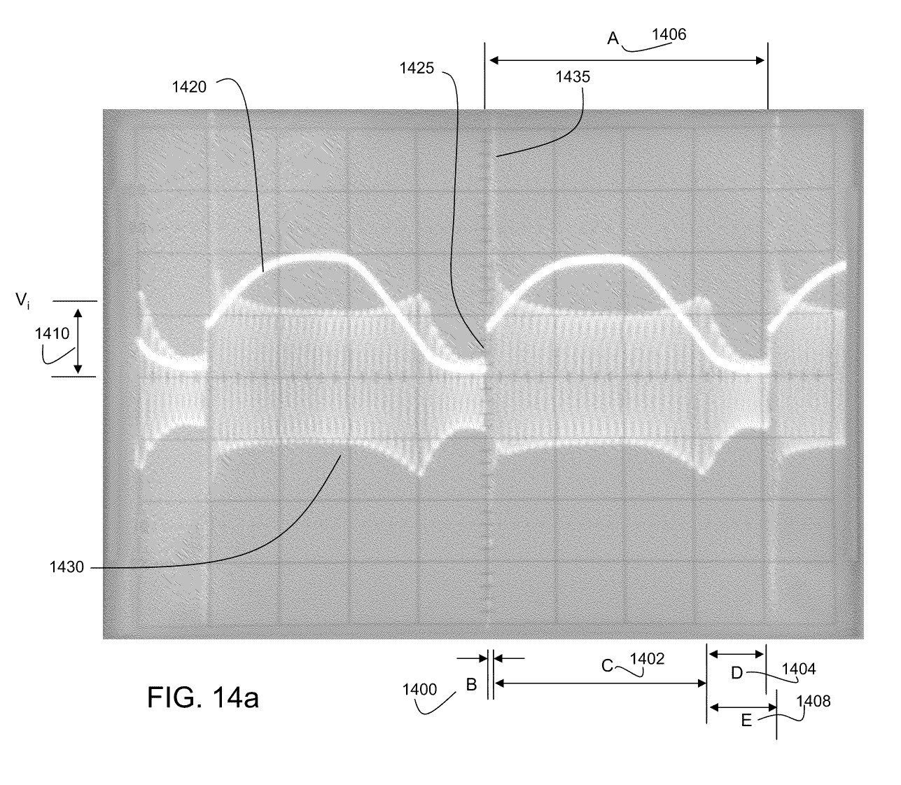

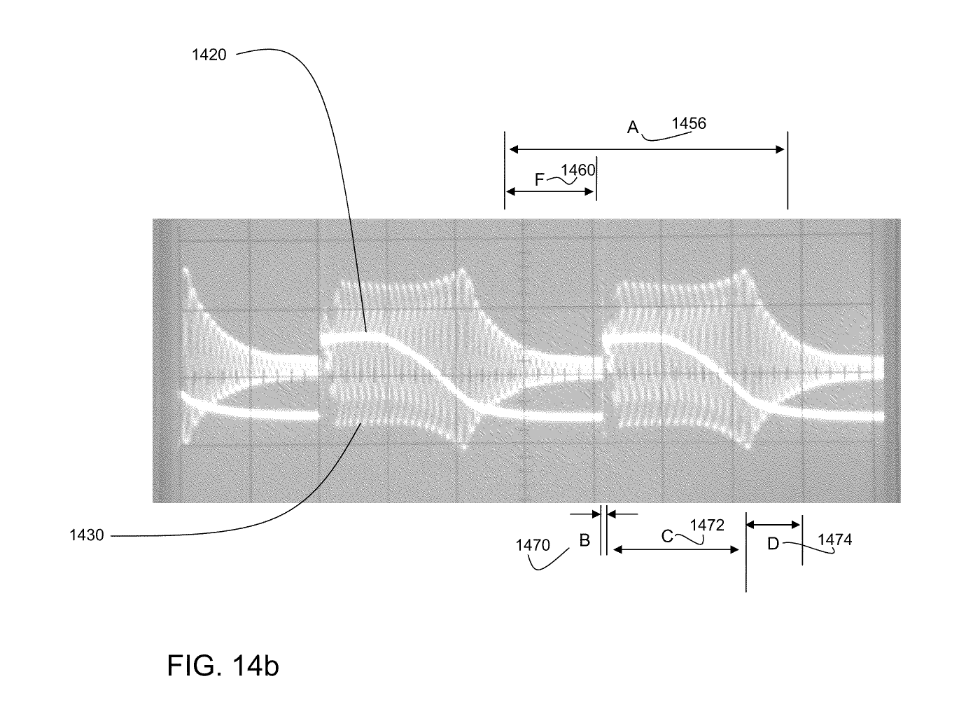

The impact of dimming on the voltage across the lamp is illustrated in FIGS. 14a-b. In FIG. 14a, the voltage waveform is shown when a dimmer is present, but no dimming is performed—e.g., the dimmer provides as much of the incoming AC voltage power to the ballast as possible. The AC rectified voltage 1420 is present and has a period corresponding to Time Period A 1406. However, the AC rectified voltage exhibits a slight ‘step function’ change 1425 at the beginning of each half cycle. This step function is because the dimmer circuit requires a certain minimum input line voltage (about 35 volts) before the diac 1307 of FIG. 13 triggers and allows the incoming AC voltage to the ballast. Thus, the ballast during Time Period B 1400 receives a near instantaneous increase in the input power. This ‘jolt’ of input voltage is amplified by the tank circuit and causes the tank circuit to generate an immediate voltage spike 1435 across the lamp. Thus, Time Period B 1400 which is the time period for tank circuit to build up voltage for ionization is relatively very short. The lamp then ionizes (which is shown as Time Period C 1402), followed by Time Period D 1404, where the lamp is not ionized.

When the dimmer is activated, it blocks a beginning portion of each AC input voltage half cycle from being passed to the ballast. The length of this portion is based on the setting of the dimmer. The effect of this is shown in FIG. 14b. In FIG. 14b the input rectified AC voltage 1420 is shown, and it still has a period of 1/120 of a second. However, the beginning of the input AC voltage is zero for the beginning portion based on the dimmer setting. Thus, in FIG. 14b, the beginning of the cycle corresponds to the beginning of Time Period A 1456. The portion in which the dimmer clamps the input voltage is shown as Time Period F 1460, which is about 33% of the total Time Period A 1456.

Once the dimmer allows the input voltage to pass to the ballast, the voltage is significantly above zero volts, and the result is that the tank circuit generates a very high and short spike during Time Period B 1470, which causes the lamp to ionize. During Timer Period C, the lamp is ionized until the input AC voltage drops in value, and Time Period D 1474 is entered. The end of Time Period D represents the end of the input voltage period. The time periods overlaid on the voltage waveforms are not to scale, and hence the end of Time Period D is approximately indicated. During this time period, the tank circuit is still resonating, and not all of the energy has dissipated, hence there is some voltage across the tube during Time Period F 1460 even though no light is being generated.

In prior art ballasts, the presence of non-ionization time is problematic because prior art ballasts are designed to continuously ionize the bulb. Prior art ballasts typically ionize a bulb once (when it is started) and are not designed to re-ionize the bulb at each half cycle. Thus, many prior art ballasts are not dimmable. Recall that prior art ballasts may incorporate a filament to facilitate initial starting and may maintain power to the filament during normal operation. When the bulb has been running, it is easier to restart a bulb after ionization is interrupted, because the gases in the bulb have been already heated. Thus, in the prior art, if the ballast is running, a certain amount of non-ionization time can be tolerated if the ballast is operated with a dimmer because the temperatures of the lamp have risen during operation and the bulb can be easily re-ionized. However, if the non-ionization time is too long, the bulb becomes difficult to re-ionize the bulb and flickering of the bulb occurs or at worst, the lamp goes out. In some prior art ballasts, when the bulb is dimmed, the ballast also reduces the current flowing in the filament. This requires a higher ionization voltage in the lamp, which the ballast may not be able readily provide. Thus, many prior art ballasts are not dimmable, or have a narrow dimming range and quickly begin to flicker when dimmed. In some cases ionization stops completely and the lamp goes out. Even if the prior art ballast is configured to quickly re-ionize the bulb, the presence of the current surge created by the bulb during ionization, along with a capacitor discharging at a high voltage level, contributes to shortening the life of the bulb. Hence, many conventional ballasts are not designed to be dimmed, or if they are, the reliability of the bulb can be adversely impacted by dimming.

In contrast, the present invention does not have these adverse impacts because the ballast is designed to re-ionize the bulb every half cycle during normal operation. Thus, the voltage waveform in FIG. 14b, which illustrates the impact of dimming, only alters the operation by increasing the non-ionization time. Because the ballast in the present invention is designed to re-ionize the bulb after the non-ionization time of each half cycle, merely increasing the non-ionization time does not impact its fundamental operation nor contribute to shortening the life of the bulb.

Further, use of the aforementioned dimmer circuit in FIG. 13 avoids any “ringing” current which can also cause the bulb to flicker. In addition, application of the filter resistor 1003 in the ballast contributes to reducing noise, flicker, and other adverse effects due in part to the ringing current which prior art dimmers may not mitigate. Thus, the present invention allows effective dimming of a CCFL over a wide range with minimal flickering.

The tank circuit of FIG. 11 can be combined with other energy savings circuitry, such as disclosed in U.S. patent application Ser. No. 12/366,886, filed on Feb. 6, 2009, entitled “Energy Saving Circuitry For A Lighting Ballast,” the contents of which are incorporated herein by reference. Specifically, a detection circuit can added to the tank circuit to detect when the tank circuit is operating as well as detecting whether the bulb has been removed. Detection of the steady state operation can be used to then activate a more efficient power source in the ballast portion 1101 which then supplies power to the integrated driver circuit 1132, while at the same time the voltage regulator in the ballast portion 1101 is deactivated. Essentially, a more efficient power source is substituted to power the integrated driver circuit.

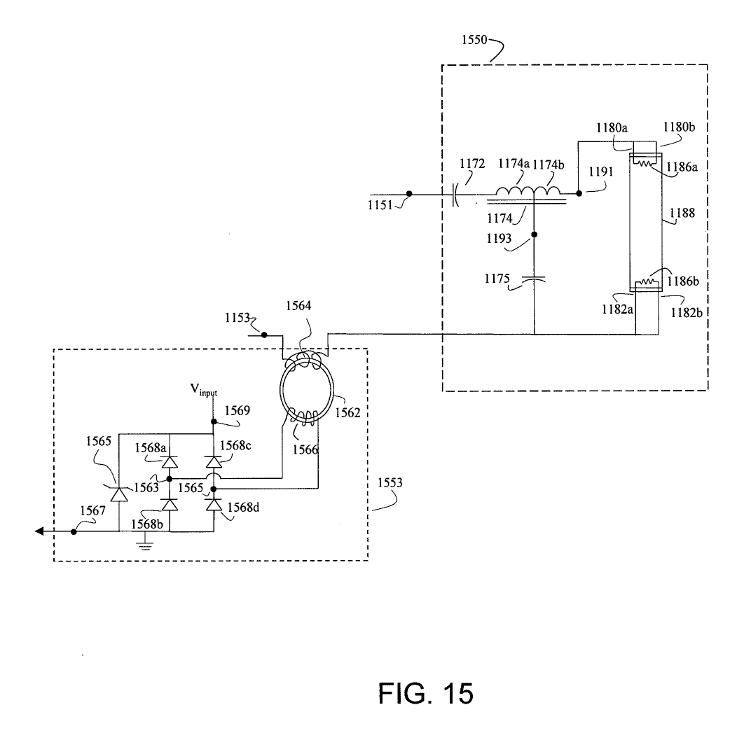

One embodiment described in the aforementioned patent application (appl. Ser. No. 12/366,886) that can be adapted to FIG. 11 involves using a current transformer detecting current in the tank circuit and is shown in FIG. 15. The current detection circuit 1553 comprising a transformer 1562 which detects a current in the tank circuit by a primary winding 1564. The transformer generates an output current via a secondary winding 1566, which in turn is provided to nodes 1563 and 1565 of a full wave bridge circuit comprising diodes 1568a-d to produce an output signal 1567. Protection diode 1565 across the full wave bridge is optional. The output signal is then used to both deactivate the voltage regulator in the ballast portion 1101 as well as act as a more efficient, alternate source of power to the integrated circuit. Details of the use and description of operation are found in the aforementioned application. However, because current will flow in the resonant circuit (e.g., specifically, current passes through node 1153 or 1193 in FIG. 11) regardless of whether a tube is installed or not, the detection circuit is unable to detect when a bulb is present. Specifically, current can flow in the tank circuit if no tube is present. This type of detecting arrangement may be suitable for a ballast having an integrated (e.g., non-removable) lamp, because the ballast is always operated with the lamp and always has the lamp present to clamp excess voltages in the tank circuit.

However, application of the current detection circuit to the tank circuit of FIG. 11 involving linear, tubular lamps that are removable, detects current even if the ballast is operated without the lamp. This can readily occur if the lamp is being replaced while the ballast is operating. In this scenario, the tank circuit voltage is not limited by the lamp. Recall that a normally functioning lamp limits the voltage across its ends by ionizing the gas therein, but if there is no lamp, the voltage is not limited and potentially unsafe voltages may develop. This does not occur in other configurations (see, e.g., FIG. 4d) because removal of the lamp may alter the resonant frequency of the tank circuit because it effectively removes the tank capacitor from the tank circuit when the bulb is removed, which impacts the frequency and reduces the voltage in the tank circuit.

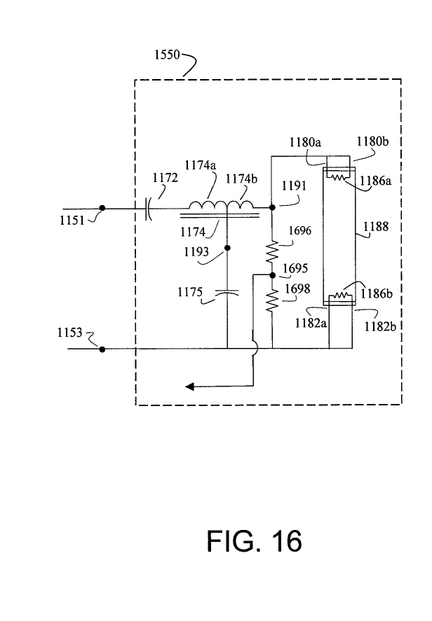

One approach to detecting the removal a bulb is shown in FIG. 16. In FIG. 16, a voltage ladder is created by placement of resistors 1696 and 1698 in series across node 1191 and 1153. Typically, resistor 1696 typically has a very high resistance (1 M Ω−10 M Ω). This high value ensures little current flow when the ballast is operating and hence very little energy is wasted). Resistor 1698 has a lower value, (1K-100K Ω) and produces a voltage at node 1695 when current is flowing. The voltage produced at node 1695 is indicative of whether the lamp is present or not. During normal, steady state operation, the voltage at node 1695 is determined by the voltage at 1191. When the bulb is removed, the voltage at node 1191 is not clamped by the bulb, and increases in value. This causes the voltage at node 1695 to correspondingly increase. Thus, the voltage at node 1395 indicates the removal or absence of the bulb.

The voltage at node 1695 can be also considered a signal voltage provided as input to the driver integrated circuit, as disclosed in the aforementioned patent application. This is used to set the switching frequency of the ballast. Thus, a change in the signal voltage can alter the switching frequency and lower the voltages produced in the tank circuit, creating a safer condition.

Further, the same voltage at node 1695 in FIG. 16 can be used to detect an end-of-life condition in the bulb. All gas discharge bulbs have a limited life, as the gas contained therein degrades, leaks out, or otherwise fails to perform as well when new. As the lamp ages, the voltage required to both initiate ionization and maintain ionization slowly increases over time. Thus, as the bulb ages, the voltage at node 1691 increases reflecting the higher voltage required. As the voltage at node 1691 increase, so does the voltage at node 1695. Thus, the voltage at node 1695 provides an indication of the lamp condition. This value can be measured, used to control the ballast, or otherwise provide information regarding the operation of the ballast and tube.

Although certain methods, apparatus, systems, and articles of manufacture have been described herein, the scope of coverage of this patent is not limited thereto. To the contrary, this patent covers all methods, apparatus, systems, and articles of manufacture fairly falling within the scope of the appended claims either literally or under the doctrine of equivalents.

What is claimed is:

1. A tank circuit for a lighting ballast configured to operate a gas-discharge lamp, comprising:
a first input node and a second input node configured to receive an alternating voltage provided across said first input node and said second input node;
a first capacitor having a first terminal and a second terminal;
a tapped inductor comprising a first portion and a second portion separated by a tap, wherein said tap is connected to a third node;
a second capacitor having a first terminal connected to said third node and a second terminal connected to said second input node; and
a fourth node, wherein said first capacitor is connected in series with said tapped inductor between said first input node and said fourth node, wherein said gas-discharge lamp is configured to be connected to said fourth node and said second input node.

2. The tank circuit of claim 1 wherein said second portion of said inductor is in series with current flowing through said fourth node.

3. The tank circuit of claim 1 configured to generate a voltage at the fourth node sufficient to cause ionization of said gas-discharge lamp.

4. The tank circuit of claim 3 wherein the inductor is sized so as to operate in a non-saturated mode when said gas discharge lamp is ionized.

5. The tank circuit of claim 1 comprising said gas-discharge lamp connected to said fourth node and said second input node, wherein said gas-discharge lamp does not comprise filaments.

6. The tank circuit of claim 5 wherein said tank circuit is part of a compact fluorescent lamp.

7. The tank circuit of claim 1 wherein said alternating voltage comprises a DC voltage and said first capacitor functions to block said DC voltage from the inductor.

8. The tank circuit of claim 1 having a resonant frequency defined by the value of said first capacitor, said second capacitor, and said first portion of said inductor.

9. The tank circuit of claim 1 wherein the first portion of the inductor comprises a first number of turns and the second portion of the inductor comprises a second number of turns, wherein further the second number of turns comprises between 20% and 40% of the first number turns.

10. The tank circuit of claim 1 wherein the gas-discharge lamp comprises two filaments, each filament having a first terminal and a second terminal, wherein said tank circuit electrically connects together each respective filament's first terminal and said second terminal.

11. The tank circuit of claim 1 configured such that said third node has a voltage not exceeding 80 volts when said tank circuit is operating.

12. The tank circuit of claim 10 wherein said second capacitor is configured to discharge energy through said second portion of said inductor.

13. A tank circuit comprising:
a first capacitor having a first terminal connected to a first input node receiving an alternating voltage, said first capacitor having a second terminal;
a tapped inductor having a first terminal connected to said second terminal of said first capacitor, said tapped inductor having a tap connected to a third node, said tapped inductor having a second terminal;
a second capacitor having a first terminal connected to said third node, said second capacitor having a second terminal connected to a second input node;
a gas-discharge lamp having a first end connected to said second terminal of said tapped inductor, said gas discharge lamp having a second end connected to said second input node.

14. A lighting circuit comprising:
a switching circuit configured to receive an input line voltage and generate an alternating voltage comprising a plurality of high frequency cycles having a frequency higher than 18 kHz, wherein said plurality of high frequency cycles has a half sinusoidal shaped envelope during a half cycle of the input line voltage;
a first capacitor having a first terminal connected to a first input node receiving said alternating voltage, said first capacitor having a second terminal;
a tapped inductor having a first terminal connected to said second terminal of said first capacitor, said tapped inductor having a tap connected to a third node, said tapped inductor having a second terminal;
a second capacitor having a first terminal connected to said third node, said second capacitor having a second terminal connected to a second input node; and
a gas-discharge lamp having a first end connected to said second terminal of said tapped inductor, said gas discharge lamp having a second end connected to said second input node, wherein the gas-discharge lamp ionizes at the beginning of each half-cycle of the input line voltage during operation of the lighting circuit.

15. A ballast circuit comprising:
a full wave bridge circuit configured to provide a rectified line voltage comprising a half-sinusoidal waveform during each half cycle of a line voltage frequency;
a switching circuit receiving said rectified line voltage and providing an alternating voltage at a switching frequency;
a first capacitor configured across the output of the full wave bridge discharging energy at said switching frequency wherein said first capacitor is of a value that does not modify said half-sinusoidal waveform of said rectified line voltage during each half cycle;
a tank circuit configured to be connected to a gas-discharge lamp,
wherein said tank circuit comprises a tapped inductor comprising a first portion and a second portion, a second capacitor, and a third capacitor,
said tank circuit configured to receive said alternating voltage across a first and second input node, said tank circuit configured to receive said energy from said first capacitor;
said tank circuit configured to generate an alternating output voltage across a first and second output node in response to receiving said alternating voltage,
wherein said second input node is electrically connected to said second output node,
wherein said alternating output voltage generated by said inductor has a peak voltage sufficient to ionize said gas discharge lamp once every half cycle of the line voltage frequency,
wherein said tapped inductor is isolated from a first DC component of the alternating input voltage by said second capacitor, and
wherein said tank circuit has a resonance frequency determined by said first portion of said inductor and said third capacitor.

16. The ballast circuit of claim 15 wherein said alternating output voltage generated by said inductor is insufficient to maintain ionization of the bulb once every half cycle of the line frequency.

17. The ballast circuit of claim 15 wherein the inductor comprises a tapped inductor having a tap, wherein a peak voltage generated at the tap is less than apeak voltage at said first output node during operation.

18. The ballast circuit of claim 15 wherein the inductor operates in a limited saturated mode during operation.

19. The ballast circuit of claim 15 wherein the alternating output voltage across said first and second output node is insufficient for a period of time to maintain ionization of the gas discharge lamp during operation of the ballast.

20. The ballast circuit of claim 19 wherein the period of time occurs every half-cycle of the input power frequency during operation of the ballast.

21. The ballast circuit of claim 20 comprising:
a bypass capacitor configured across an output of a full wave bridge receiving input power, said bypass capacitor having a capacitance of less than 2 μF.

22. A method of operating a tank circuit in a lighting ballast, comprising the steps of:
receiving an alternating input voltage at a first input node and a second input node at the tank circuit;
generating an alternating output voltage at a third node in the tank circuit, wherein a first capacitor and an inductor are connected in series between said first input node and said third node, wherein said inductor has a tap, said alternating output voltage is provided to a first terminal of a bulb, wherein said bulb has a second terminal connected to said second input node; and
charging a second capacitor in response to a third voltage generated at the tap wherein said second capacitor has a first terminal connected to said tap and a second terminal connected to said second input node.

23. The method of claim 22 wherein during operation of said lighting ballast, said alternating output voltage increases to a first level during a first time period sufficient to ionize said bulb, said alternating output voltage decreases to a second level during a second time period sufficient to maintain ionization of the bulb, said alternating output voltage decreases to a third level during a third time period insufficient to maintain ionization of the bulb, wherein said first time period, said second time period, and said third time period occur during a single half-cycle of a power line input voltage.

24. The method of claim 22 wherein the alternating output voltage decreases to a level wherein the bulb is not ionized during every half-cycle of the power line input voltage.

25. A ballast circuit comprising:
a full wave bridge circuit configured to provide a rectified line voltage having a half-sinusoidal waveform during each half cycle of a line voltage frequency;
a switching circuit receiving said rectified line voltage and providing an alternating voltage at a switching frequency, said alternating voltage comprising a plurality of cycles with an envelope in a shape of the half-sinusoidal waveform;
a first capacitor configured across the output of the full wave bridge discharging energy at said switching frequency;
a tank circuit configured to be connected to a gas-discharge lamp in a cold cathode configuration, said gas-discharge lamp connected to a first output node and a second output node,
said tank circuit configured to receive said alternating voltage across a first and second input node,
said tank circuit configured to generate an alternating output voltage across said first output node and said second output node in response to receiving said alternating voltage,
wherein said alternating output voltage is sufficient to ionize said gas discharge lamp once every half cycle of the line voltage frequency, and
wherein said alternating output voltage is insufficient to maintain ionization of the said gas discharge lamp once every half cycle of the line frequency.
